(19) United States
(12) Patent Application Publication
(10) Pub. No.: US 2026/0087057 A1
(43) Pub. Date: Mar. 26, 2026

(54) ARTIFICIAL INTELLIGENCE ENHANCEMENTS FOR DOCUMENT INTERFACES

(71) Applicant: MicroStrategy Incorporated, Vienna, VA (US)

(72) Inventors: Abdul Rahman, Warsaw (PL); Erika Patricia Moreno Gamboa, Aldie, VA (US); Jose Nocedal, Vienna, VA (US); Divya Singh, Chantilly, VA (US); Qiong Wu, Vienna, VA (US); Yali Guo, Vienna, VA (US); Tao Chen, Vienna, VA (US); Lingping Zhu, Vienna, VA (US); Haifeng Wang, Vienna, VA (US)

(21) Appl. No.: 19/332,862

(22) Filed: Sep. 18, 2025

Related U.S. Application Data
(60) Provisional application No. 63/696,983, filed on Sep. 20, 2024.

(51) Int. Cl. G06F 16/34

(52) U.S. Cl. CPC G06F 16/345

(57) ABSTRACT

Methods, systems, and apparatus, including computer-readable media, for artificial intelligence enhancements for document interfaces. In some implementations, a system receives data indicating a user interaction of a user at a user interface that displays a document. In response, the system determines a scope of data corresponding to a particular portion of the document. The system retrieves data for the determined scope corresponding to the particular portion of the document. The system performs one or more analysis processes on the retrieved data to generate analysis results for the retrieved data. The system sends a request to one or more artificial intelligence and/or machine learning (AI/ML) models, wherein the request comprises (i) at least a portion of the retrieved data, (ii) the analysis results, and (iii) a predetermined instruction. The system provides text generated by the one or more AI/ML models for presentation in the user interface with the document.

### CROSS-REFERENCE TO RELATED APPLICATIONS

This application claims the benefit of priority to U.S. Provisional Patent Application Ser. No. 63/696,983, filed on Sep. 20, 2024, the entire contents of which is incorporated by reference herein.

### BACKGROUND

The present specification relates to techniques for determining and revealing interpretations made by models for artificial intelligence and machine learning.

Artificial intelligence (AI) and machine learning (ML) techniques have improved significantly and continue to gain new capabilities. For example, neural network models, such as large language models, have shown the capability to process and to generate many types of natural language text. For example, chatbots that leverage large language models can respond to user prompts (e.g., user inputs such as questions) in text-based messaging sessions or conversations with users.

### SUMMARY

In some implementations, a computer system can enhance the content shown on an interface, such as by adding supplemental analysis results to a document interface. The computer system can generate additional content that is coordinated with or corresponding to the content shown on a user interface using AI/ML models and non-AI/ML models. The additional content or enhancement data can be presented on the same interface to supplement the presented content. The generated enhancement data can include, for example, narratives, descriptions, and other visualizations, which provide additional context to supplement the content or data shown on the interface. For instance, the enhancement data can emphasize important or necessary information extracted from the content on the interface for the benefit of a user interacting with the interface.

In some implementations, the computer system can tailor the enhancement data for content currently shown on a user interface. Generally, the content displayed on the user interface may include, for example, one or more pages of a document, a visualization (such as a chart or graph), another content type, or multiple content types. The computer system can produce the enhancement data that is generated based on relevant content shown on the display, for example, according to user-selected elements shown on the display. In this manner, the computer system can generate and present enhancement data for a targeted data scope, which can be a particular subset of a document or data set that a user is viewing or interacting with. For example, the computer system can generate enhancement data based on a subset of data that is selected by the user or is visible in the user interface (e.g., a subset that can exclude data that is not selected by the user or is not visible in the user interface), so the generated content is relevant for the current view in the user interface.

In some implementations, the user can perform an action or provide an input that requests or triggers the generation of enhancement data. For example, in some cases a user may submit a text request to a chatbot interface that requests an explanation or description of items shown in a user interface. In many other instances, however, the computer system can make new and useful information available without requiring the user to submit any question or text prompt. For example, the user interface can include a button or other control to request further content, and when the user clicks or otherwise interacts with the control, the interaction initiates the generation and display of information targeted to the current state of the user interface. To facilitate this, a document or a particular portion of a document (e.g., a page, a visualization, etc.) can have a set of instructions defined in advance to specify the type of additional content that should be generated and presented when the control is interacted with. A document creator or an administrator can specify this type of instruction to customize the user experience, allowing advance guidance for the later creation of dynamically-generated content with AI/ML models. Based on the predetermined instruction and the current state of the document and related data sets in the future, each user session that generates additional content can apply the predetermined instruction to create a customized set of content for the user's current view (e.g., user filter settings applied, data ranges currently selected in the document, visualizations or elements selected by the user, etc.). In some cases, the computer system can trigger the generation and/or display of enhancement data according to other criteria, e.g., changing currently viewed content, adjusting filters for the interface, and changes selected content, to name a few examples.

The computer system can support interactive applications where processing tasks for responding to a user prompt are split between non-AI/ML or non-probabilistic data processing systems (e.g., database management systems) and AI/ML models. For example, when a user prompt such as a natural language query is received, the computer system can use a database system to generate a set of result data that is relevant to the user prompt. The set of result data can then be processed using one or more AI/ML models, such as a large language model, to generate content to present in a response to the user. This system can combine the strengths of AI/ML models and non-AI/ML processing systems to provide a chatbot or another application with responses that are more complete, accurate, and reliable than either type of processing system on its own.

In general, many AI/ML models have excellent generative capabilities and the ability to produce high-quality natural language output. However, AI/ML models also often have significant limits. For example, AI/ML models typically use probabilistic processing, which may generate responses that are generalized or approximate, and so may not adequately answer a user's question or may lack the accuracy or precision needed. In some cases, AI/ML models provide content that includes hallucinations or other information that may be statistically plausible given training data but is actually factually incorrect. The probabilistic nature of AI/ML models can also result in the same user prompt resulting in significantly different responses at different times, which can decrease users'confidence and ability to rely on the responses. For example, the same question may yield different numerical answers when the question is asked multiple times to an AI/ML model, even when the source data set has not changed.

As discussed further below, the computer system can provide chatbots and other interactive applications that combine the advantages of AI/ML models and the reliability and accuracy of other non-AI/ML or non-probabilistic data processing systems, such as relational database systems. Database management systems and other systems can reliably provide result data that is accurate and reliable, calculated from the source data using proven and validated processes. For example, data processing systems can be used to search a data set and make calculations, perform aggregations, and generate values in a data series in a repeatable or deterministic manner. This can be done even over large data sets, which may be much larger than an AI/ML system can accept as input context. In addition, the processing can be focused on the specific data set of interest, without extraneous data influencing the calculations as might occur in the probabilistic processing of an AI/ML model trained on large quantities of other data.

When the interactive application is used to respond to a user prompt, the non-AI/ML data processing system (e.g., a database management system) generates result data relevant to the user prompt (e.g., user's question) from the source data set. The user prompt and the result data set, potentially with other information and context, can be provided to the AI/ML model to generate text output for the response to the user. For example, the computer system can send a for the AI/ML model to summarize the result data set or to generate a response to the original user prompt from the result data set that has been generated. As a result, the text that the AI/ML model generates can draw from values calculated accurately from the source data set, without requiring the AI/ML model to be capable of generating those values itself or without the AI/ML model even accessing the data set. As a result, the output to the user combines the reliable, accurate calculations from the non-AI/ML system with the text and other information provided by the AI/ML model from the result data set.

Combining the processing of AI/ML systems and non-AI/ML systems in the chatbots enhances privacy by limiting the amount of data that the AI/ML model or any other third parties receive. This can provide users with higher confidence in using the system, as well as allow the use of a wider range of third-party AI/ML service providers. When processing queries relating to a data set, the AI/ML model does not need to receive the full contents of the underlying dataset that the chatbot is based on. Indeed, in many cases, the AI/ML model does not receive even portions of the actual dataset, and instead receives only metadata describing the general contents and/or structure of the data set (e.g., types of metrics and attributes, semantic meaning of the columns, etc.) and potentially sample data (e.g., fictitious examples that illustrate the type of content in the dataset without revealing the actual values and records). In addition to enhancing privacy, this also increases speed and reduces network transfer requirements, since the dataset does not need to be sent over a network and the dataset itself does not need to be processed by the AI/ML model. The process also allows the data processing system (e.g., an enterprise database management system) to reliably apply security policies and access control over the dataset that the AI/ML model typically would not be capable of applying. After the data processing system performs processing to generate a result data set, the AI/ML model is provided the result data set and asked to generate a summary. In this interaction, the AI/ML model receives the result data set that generally includes aggregated or composite information specifically answering the user's question, and the AI/ML model does not receive access to the underlying dataset itself. As a result, the system avoids granting the AI/ML model—and any third-party providing the AI/ML model as a service—access to portions of the dataset that are not appropriate for answering the current question.

In general, splitting response generation among multiple processing systems, e.g., an AI/ML model and a database management system, increases the quality of output and control over the process of generating responses. The arrangement also facilitates customizability by allowing administrators to select different AI/ML models and different AI/ML service providers to customize their chatbots. With the system performing discrete operations leveraging AI/ML models, separate from the core querying of an enterprise's proprietary datasets, the chatbots can be more easily integrated with the processing capabilities of third-party systems.

In some implementations, a method performed by one or more computers includes: receiving, by the one or more computers, a request to generate supplemental content that describes content displayed by a client device; identifying, by the one or more computers, a set of predefined instructions corresponding to the content displayed by the client device; generating, by the one or more computers, analysis data using the data from the request and one or more models; obtaining, by the one or more computers, output from one or more machine learning models that processed the set of predefined instructions and the generated analysis data; and providing, by the one or more computers and to the client device, a response for display, the response comprising the supplemental content representing the obtained output.

In one general aspect, a method performed by one or more computers includes: receiving, by the one or more computers, data indicating a user interaction of a user at a user interface that displays a document; in response to receiving the data indicating the user interaction, determining, by the one or more computers, a scope of data corresponding to a particular portion of the document; retrieving, by the one or more computers, data for the determined scope corresponding to the particular portion of the document; performing, by the one or more computers, one or more analysis processes on the retrieved data to generate analysis results for the retrieved data; sending, by the one or more computers, a request to one or more artificial intelligence and/or machine learning (AI/ML) models, wherein the request comprises (i) at least a portion of the retrieved data, (ii) the analysis results, and (iii) a predetermined instruction to the one or more AI/ML models that was not provided by the user; and providing, by the one or more computers, text generated by the one or more AI/ML models for presentation in the user interface with the document in response to the user interaction.

In some implementations, receiving the data indicating the user interaction comprises receiving data indicating the user interaction from a user device over a network; and providing the text comprises providing the text over a network to the user device.

In some implementations, determining the scope of data corresponding to the particular portion of the document comprises at least one of: determining one or more data series described or represented in a current state of the document; determining the scope of data representing data currently viewable in the user interface; determining the scope of data based on one or more filter settings applied by the user; or determining the scope of data based on a selection in the user interface made by the user.

In some implementations, retrieving data for the determined scope comprises at least one of: accessing cached database retrieval results used to generate the particular portion of the document; obtaining results of a database query used to generate content in the user interface; accessing data corresponding to a user-selected portion of the user interface; or accessing data corresponding to the document based on a session identifier corresponding to the user interface, a document identifier for the document, a page identifier for a page in the document.

In some implementations, the method includes storing the predetermined instruction in association with the document before the document is displayed in the user interface in a current session; and wherein the method includes generating the request based on the stored predetermined instruction.

In some implementations, determining the scope comprises determining at least one of: a data set corresponding to the particular portion of the document; one or more data series represented in the particular portion of the document; or one or more values in which to filter or restrict a data set.

In some implementations, the particular portion is a particular page of the document, a particular visualization in the document, a particular view of the document, or a user-selected portion of the document.

In some implementations, the provide a narrative summary of a visualization, determined based on analysis of underlying data series shown in the visualization.

In some implementations, the document is a dynamic document that is linked to a data set, wherein content of the document is configured to vary based on changes in the underlying data set, and wherein the retrieved data is based on data used in a state of the document at the time the user interaction occurred.

In some implementations, the dynamic document is a dashboard configured to adjust displayed content based on user settings for one or more interactive controls in the user interface; and wherein the scope of the data is determined based on the user settings for the one or more interactive controls.

In some implementations, the request to the one or more AI/ML models further comprises information from a data model for a data set used to generate content of the document.

In some implementations, the document comprises multiple different objects or components in the document, and wherein the predetermined instruction comprises a reference to one or more of the objects or components in the document.

In some implementations, the objects or components comprise a visualization, and wherein the predetermined instruction comprises text instructing the one or more AI/ML models to generate a summary of the visualization.

In some implementations, the method includes storing multiple different custom instructions corresponding to different data types or different portions of the user interface; wherein the one or more computer are configured to use different instructions of the stored custom instructions to generate a request to the one or more AI/ML models depending on a user interface element interacted with or a portion of the document displayed in the user interface.

In some implementations, performing the one or more analysis processes on the retrieved data comprises performing at least one of trend analysis, key factor analysis, and forecasting analysis.

The details of one or more embodiments of the invention are set forth in the accompanying drawings and the description below. Other features and advantages of the invention will become apparent from the description, the drawings, and the claims.

### BRIEF DESCRIPTION OF THE DRAWINGS

FIG. 1 is a diagram showing an example of a system for using artificial intelligence or machine learning (AI/ML) models to enhance document interfaces.

FIGS. 2A-2B, 3A-3B, 4A-4B, 5A-5B, and 6-11 are diagrams showing examples of user interfaces that show techniques for enhancing document interfaces using AI/ML models.

Like reference numbers and designations in the various drawings indicate like elements.

### DETAILED DESCRIPTION

In some implementations, a computer system includes features to enhance document interfaces using AI/ML models such as large language models (LLMs). For example, the system can be configured to supplement the displayed content of a document with additional, dynamically-generated elements that can emphasize or call out significant features of the document. The system can use AI/ML models to analyze document content or the underlying source data, to identify and specify to the viewer features that are most important. The system can generate and provide supplemental information that is accurate and applicable for the current state of the document as it is viewed, including the current document content and connected data sources that the document draws from, as well as current user selections that show data sets, ranges, or document elements of interest to the viewer.

The system can provide useful enhancements for documents such as dashboards, dynamic reports, web applications, and other documents that connect to data sources such as data warehouses, databases, data cubes, and so on. In many cases, documents that connect live data sources may have different content from time to time, such as each time the document loads, from one session of use to another, or as a data set grows or as new database entries are added. For example, a dashboard may have a chart showing status over time, and the chart may be updated each time the document is loaded, when the dashboard is refreshed, automatically as new status entries are added to the associated data set, when the user changes a filter or display setting for the dashboard, and so on. As a result, the scope of data represented in a view of the document can change, and the important features of the data (and any tables, text, or visualizations based on the data) can also change. In this situation, a static summary or statistical analysis (e.g., a stored or pre-generated description) would often not be accurate or complete for the current view of the document and the current state of the data set at the time the user is using the document.

The system can provide accurate and customized content to supplement document interfaces, by using AI/ML models to generate supplemental content based on the result data that is used to generate the document content. For example, a document can include visualizations (e.g., charts, graphs, maps, tables, etc.) that represent result data that is generated by processing data (e.g., applying filters, aggregations, calculations, conditional logic, etc.) in a source data set. The system can access this result data and process it with an AI/ML model, such as an LLM, to extract and summarize important features of the result data (e.g., statistical features, relationships, trends, etc.). For example, if the current page of a document includes a line graph, the system can access the same data series represented in the line graph and use a LLM to concisely describe the important features of the line graph. The system can provide the result data to the LLM with labels or tags that identify the object type or data type of the data used (e.g., to indicate that data corresponds to specific attributes and metrics such as date, time, inventory level, street address, etc.). The system can also provide a data model to the LLM, where the data model indicates the semantic meaning of the various objects or types of data provided in the result data. As a result, the system can enable the LLM to generate output that correctly interprets the result data based on the content of the data model. In some implementations, the system can also provide the LLM with data processing instructions (e.g., a structured query language (SQL) statement, Python code, etc.) used to generate the result data from the source data set, which can further assist the LLM to interpret the result data.

The system can determine and obtain an appropriate scope of data for the supplemental content. This process can include identifying a particular portion of a document that is currently relevant, such as a particular section or page that is being viewed or one or more document elements (e.g., tables, visualizations, etc.) that the user has selected in the user interface. The system can also determine filter settings that have been applied and apply those same filter settings to the result data provided to the LLM. For example, if the current view of a document has a user-adjusted filter for a range of time, set of locations, or another dimension, the system can maintain that filter on the result data supplied to the LLM for analysis.

When the system obtains the result data corresponding to a visualization or other document content, the system can retrieve the result data efficiently from a cache or other temporary data storage or from the document content itself (e.g., metadata or an embedded object). The system can thus obtain a copy of the same result data that was used to generate visualizations or other document content when the document view was loaded. This can help ensure consistency between the AI/ML model-generated supplemental content and the data shown to the user in the document, because both are based on the same result data set. In addition, this provides high efficiency because the result data is obtained without the need to query the database or other source data set again, thus minimizing latency and conserving network bandwidth and processing resources.

The system can trigger the generation of supplemental content based on appropriate events or conditions and refresh the supplemental content as needed. In general, the system provides the ability to synchronize or maintain consistency between displayed document content and supplemental content generated using an LLM. In some implementations, the supplemental content is generated in response to a request by a user, such as by the viewer of a document selecting a button or other control designated to initiate presentation of additional analysis or description of the document. In some implementations, depending on settings for the document or an application that displays the document, the system can trigger the generation and/or display of supplemental information for the document in response to a request to load the document, or in response to a change in a view of the document (e.g., switching from one page to another), as the viewer changes filter settings, as the viewer scrolls from one page or section to another, as the viewer changes a selection of elements within the document, etc. (e.g., if requested or as page view or filter changes).

The type of supplemental content that is shown for a document is configurable and can be customized for each document or at a more fine-grained level. For example, the system can enable administrators or document creators or editors to specify a custom instruction to the LLM to be used when generating supplemental content for a specific document. This custom instruction can be a prompt for a LLM that can refer to particular result data using identifiers for elements of the document (e.g., particular visualizations) or for objects in the data model for the data set(s) that are used to provide the document content. For example, a custom instruction may be a predetermined set of text that serves as a LLM prompt template, and which can reference one or more visualizations in the document or one or more attributes and metrics. When the system later generates supplemental content for the document, the system can retrieve the actual values corresponding to the current state of the object(s) referenced in the custom instruction. For example, for a simple custom instruction of “Summarize GRAPH1,” the system can retrieve the result data currently represented in the visualization with identifier GRAPH1, given the up-to-date content of the data set and including the effects of any filters or other adjustments applied by the viewer. The stored custom instruction is then formulated into a specific text prompt to the LLM, which can be to summarize the retrieved result data corresponding to the current state of the GRAPH1 object. The request can be sent to the LLM with additional content, such as data describing the GRAPH1 object, a data model for the source data set (or at least the attributes and metrics used in the GRAPH1 object), and so on.

Dashboards or other documents may include many elements in a single page or view, which can make it difficult for a LLM to effectively determine which elements are most important or significant and so should be summarized or highlighted for a user. By including settings in documents to save a predetermined custom instruction, the system allows user that create documents to customize the nature of the supplemental content that will be later generated by viewers. This customization can be specified and saved on a document-by-document basis, or may be done page-by-page or section-by section within a document, to customize the results when a viewer later activates generation of the supplemental content. The document creator can use the custom instruction to specify objects or data from a document, and the type of information to be generated (e.g., summary, trends, relationships, statistics, minimum and maximum values, etc.). Then, when the document is viewed, the system can dynamically retrieve the actual values for the scope of data the document creator defined and provide those values with an appropriate request to an LLM. Even though the document creator will not know in advance factors such as the particular range of data that will be shown or the set of filters that will be applied, the system can later automatically include or transfer those aspects as currently set at the time the document is viewed or a supplemental content request is initiated.

When a user is editing a custom instruction for a document, the system can provide an editing interface that assists the user by indicating the objects that are in the scope of the document or a particular portion of it. For example, the interface can include autocompletions, drop-down lists, or other selection features that give access to a set of objects (e.g., attributes, metrics, visualizations, etc.) that is limited to the scope of a page the custom instruction is being set for. As a result, the system can guide the user to define a custom instruction that corresponds to the scope of data represented in a particular page, section, or other view of a document.

The system can be configured to perform additional analysis to improve supplemental content, automatically and beyond the type of analysis requested in the custom instruction. For example, the system can be configured to analyze the result data to identify trends, relationships, and other features. Examples include forecasting, key driver analysis, trend analysis, regression modeling, and clustering. In many cases, the analysis performed by the system may use algorithms, machine learning models, or techniques that are not available to an LLM, and so could not typically be performed effectively by an LLM. In this manner, the system can perform analysis that extends beyond the capability of the LLM. The analysis by the system can be more accurate than an LLM, which uses probabilistic processing and often gives approximate or estimated answers. By contrast, the system can use specialized models or processes that are designed to accurately calculate relationships, trends, and other features from result data. The analysis results can be provided to the LLM with the result data and the custom instruction, with the analysis results being included among the context or source data from which the LLM can draw to generate its answer.

As an example, the custom instruction for a document page may specify to summarize a visualization. Based on this custom instruction, the system can send a prompt to the LLM that requests a summary of set of data that includes (1) the result data shown in the visualization and (2) the analysis results the system generated (e.g., from trend analysis, forecast analysis, key factors identification, regression analysis, etc.). Including the analysis results increases the likelihood that the LLM can generate output that specifies the types of relationships and trends that are important, because the LLM may not have the capability to identify those items from the values in the result data set alone. In addition, even if the LLM could predict that those types of information would be useful, the probabilistic nature of LLMs and inconsistency from one situation to the next makes the analysis results calculated by the system, using more appropriately trained or calibrated models or algorithms, more accurate and reliable for the user.

In some implementations, the system can perform additional analysis (e.g., trend analysis, key driver analysis, forecasting, regression modeling, etc.) automatically, without it being specified by any settings for the document or in the custom instruction set by the document creator. As a result, the system can enhance the AI/ML-generated supplemental content with this additional analysis without any user or any document-related configuration requesting the analysis to be performed. In other implementations, the system may selectively perform the analysis, for example, based on the contents of the result data, settings for the document, or text of the custom instruction. For example, the system can perform forecasting analysis only when the result data is of a type that the system detects is appropriate for this type of analysis, e.g., when the result data includes time series data or another sequence of data points that satisfies conditions needed for performing time series analysis, or the custom instruction mentions a keyword or topic associated with forecasting analysis.

When the system provides supplemental content for a document, the process can be transparent to the end user. For example, the stored custom instruction and other settings can be retrieved and applied by the system without requiring any text input or prompt generation by the viewer of the document. This can greatly increase the efficiency of interacting with the document, as well as conserve limited screen space. Unlike prior approaches that may require a chatbot interface with text entry and text fields, the system can use the previously-defined, stored custom instruction, without showing or requesting any text prompt or question from the viewer of the document. The viewer can trigger the generation and/or display of the supplemental content simply by interacting with a small user interface element (e.g., a button, target area, an icon, or other control). From this simple trigger, the system gathers the appropriate result data for the currently applicable portion of the document (e.g., the current page or a user-selected visualization in the page), as well as associated data model information and supplemental analysis of the result data, and instructs the LLM to provide a response according to the custom instruction. This approach also increases speed because there is no need to wait for a user to formulate a question, enter it, and have it processed. Instead, the stored instruction can be used without delay when a request for supplemental content is made.

Even if the viewer does not understand the content of the document enough to ask an appropriate question, the system can still provide supplemental content indicating the most significant features of the current document view. The system's use of stored instructions and dynamic sourcing of the appropriate scope of result data for the document view makes it so the viewer is not required to provide any guidance to the system. In many cases, the custom instruction is hidden so that it is not even displayed or revealed to the viewer. As a result, without a chatbot interface and without any instruction from the viewer, the system can provide the viewer supplemental content indicating the most significant features of the current document view, where the supplemental content is coordinated and matched to what is visible in the current state of the document (e.g., with selections, filters, and other settings of the viewer applied). The system can be configured so that any of various events trigger generation and display of the supplemental content, such as a user interaction with a user interface element, loading of the document, the user changing a filter setting, a change in the data represented in a visualization of the document, the user changing a selection on the user interface, changing of a view of the document (e.g., scrolling to a different page), and so on.

As discussed further below, the instruction for generating the supplemental content can have any of various features. In some implementations, the supplemental content includes a summary, or a narrative description of the data or relationships present for specific attributes, metrics, or objects in the document. Similarly, the supplemental content can include text that interpret or explains aspects of the data series in the document. The supplemental content can include statistical features, such as maximum values, minimum values, mean values, trend directions, and other measures. In addition to text and values, the stored instruction can include other types of content, such as markup language content (e.g., HTML), JavaScript content, conditional formatting rules, and other code that can tailor the supplemental content. Because the underlying data set that the document is generated based on can be dynamic and change over time, the supplemental content can also be dynamic and can change from time to time, being re-generated using the LLM in different sessions or uses of the document.

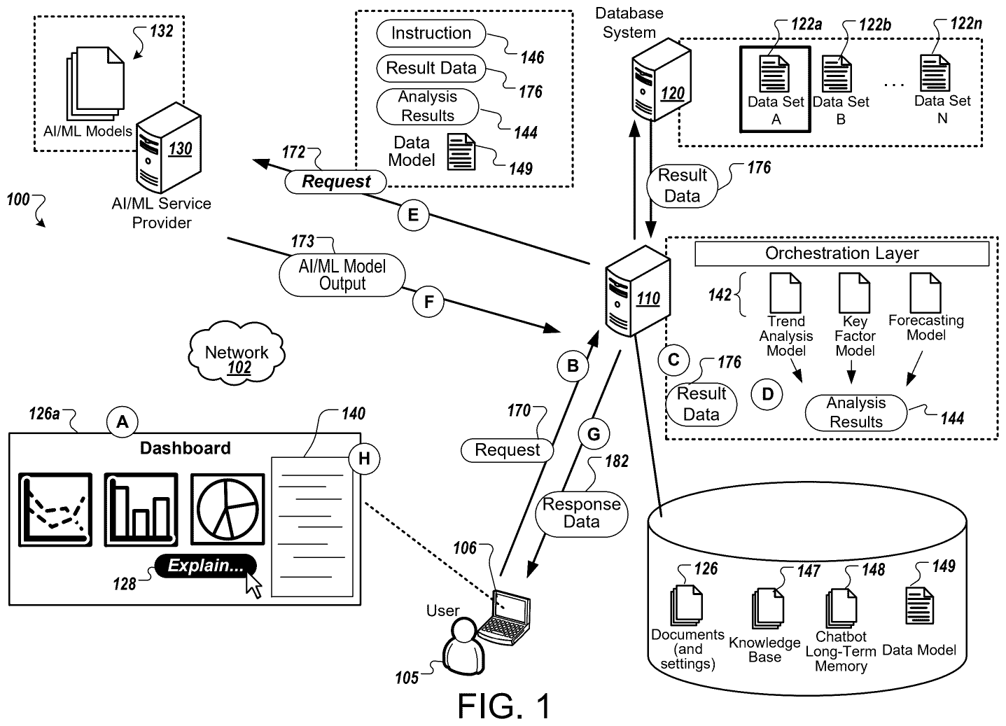

FIG. 1 is a diagram showing an example of a system 100 for using AI/ML models to enhance document interfaces. The system 100 includes a computer system 110, a database system 120, and an AI/ML service provider 130. The system also includes a client device 106 of a user 105. The elements of the system 100 communicate over a network 102, such as the Internet. The computer system 110 coordinates a variety of operations to provide and manage access to documents, as well as chatbots and other AI/ML applications. The computer system 110 can store various documents 126, e.g., dynamic documents, that can be hosted or served by the computer system 110 or another server system. The computer system 110 can store data associated with models 142 in the knowledge base 147, e.g., prior inputs and outputs, prior versions of the models, and data used for improving the models 142. The computer system 110 can store, in the chatbot long-term memory 148, data associated with inputs provided to a chatbot and supplemental data produced by the computer system 110 and provided to the client device.

In the example, the user 105 has loaded a particular document 126a using the client device 106. The document 126a in the example is a dashboard that includes at least some text, images, visualizations (e.g., charts, graphs, maps, tables, etc.), or other content from a data set 122a stored by a database system 120. The computer system 110 coordinates the delivery of document content to the client device 106 to load the dashboard, such as to retrieve stored document content, to obtain result data 176 from the data set 122a from the database system 120 to be shown in the document 126a, and to provide the data to be shown in a view at the client device 106.

With the document 126a loaded and a view of the document 126a displayed at the client device 106, the computer system 110 can enhance the interface showing the document 126a with supplemental content 140 beyond what was specified or defined for the document 126a. For example, the computer system 110 can use an AI/ML model 132 and other techniques to analyze the result data 176 represented in the visualizations shown in the document 126a, to create supplemental content 140 that describes, interprets, or explains the most significant aspects of the result data 176. Part of this process can include the computer system 110 processing the result data 176 further by running additional analysis on using its own models 142 to generate analysis results 144. The analysis results 144 can be provided with the result data 176 to specify relationships, trends, and other information that the AI/ML model 132 (e.g., an LLM) may not be able to perform as well or as accurately. The actual request to the AI/ML model 132 can be based on a stored instruction 146, which can be customized for the document 126a or even for a particular portion of the document 126a (e.g., a particular section, page, component, or visualization in the document 126a).

The process of obtaining the supplemental content 140 can be very simple and seamless for the user 105. For example, the document interface can include a user interface element 128 that is configured to trigger generation and presentation of the supplemental content 140. When the user 105 interacts with the user interface element 128, the computer system 110 can generate the supplemental content 140 based on the stored instruction 146 and the current state of the document 126a (e.g., the current page or section in view, any selections or filter settings made by the user 105, and the content of the associated source data set 122a for the document 126a). As a result, with a single user interaction, and with no need for the user 105 to formulate a question or text prompt, the computer system 110 can generate and provide supplemental content 140 that describes important relationships and data characteristics in the current view of the document 126a by the user 105, even if the user 105 has applied customized filters, range selections, and other document settings. Because the computer system 110 aligns the result data analyzed by the AI/ML model 132 with the result data shown or represented in the current document view, the supplemental content 140 can be coordinated with and targeted to the actual data represented in the current view of the document 126a.

The example of FIG. 1 includes stages (A) to (H), which represent various operations and a flow of data, and which can occur in the order illustrated or in a different order.

The computer system 110 can be implemented using one or more servers, such as one or more cloud computer systems, one or more on-premises servers, etc. For example, the computer system 110 can be an application server. The computer system 110 provides front-end functionality to interface with various client devices. For example, the computer system 110 can provide an interface for creating and editing chatbots and other interactive applications that leverage AI/ML models. The interface can be an application programming interface (API), a user interface (e.g., by providing user interface data for a web page or web application), or another type of interface.

The database system 120 can provide various data retrieval and processing functions. For example, the database system 120 can be a database management system (DBMS) and can include the capability to process operations specified in structured query language (SQL), Python code, or in other forms. The database system 120 has access to various datasets 122a-122n, which can be private datasets for organization, such as a company. The database system 120 can store and use datasets in any of various forms such as relational database tables, data cubes, or other forms.

For each data set 122a-122n, the computer system 110 can store or access a corresponding data model 149. The data model 149 can include information about the nature of a data set, such as the types of attributes, metrics, columns, or other objects in the corresponding data set, without providing the actual content (e.g., values) of the data set. For example, the data model 149 can include a data schema for the data set 122a. In general, the data model 149 can indicate a list of logical objects represented in the data set 122a, such as a list of the elements or components of the data set, such as metrics, attributes, facts, and so on. For example, the data model 149 can indicate that the data set 122a includes logical objects such as date, customer identifier, region code, sales amount, and so on. These data objects can represent quantities or data objects that are represented in, or can be derived from, data in the data set 122a. The logical objects, such as metrics or attributes, can represent the type of data that is stored in or derived from a column of data. For example, an attribute may represent a type of data stored in a column of a data table or the result that would be obtained by applying a particular arithmetic expression to data in a column. Similarly, a metric or fact can represent the result of applying a particular aggregation function or other operation(s) to values in one or more columns of a data table. Accordingly, the data model 149 can indicate the attributes and metrics that are available for the AI/ML model 132 to work with, and potentially additional attributes or metrics that can be generated or operations that are available for the database system 120 to create a new attributes or metrics.

In some cases, the data model 149 can indicate, through the logical objects identified, data from tables, columns, and other elements that make up the data set 122a, in addition to or instead of the semantic meanings and/or relationships among these elements of the data set 122a. For example, the data model 149 can indicate that the data set 122a includes set of data named “sales_table,” that includes a metric named “sales_amount” that indicates amounts of sales and another attribute named “region” that indicates the region in which the sale occurred. These quantities may or may not correspond directly to the structure of the data set 122a. For example, the item “sales_table” may be an actual data table of a database, or may not represent a table and instead another grouping of data. Similarly, the “sales_amount” and “region” objects may correspond to specific columns of a data table, but may alternatively represent values that can be calculated or otherwise derived from the data set 122a in another way.

As discussed below, the data model 149 can be provided to an AI/ML model 132 to enable the AI/ML model 132 to appropriately interpret and refer to the appropriate logical data objects. Providing the data model 149 can give the AI/ML model 132 a list and description of the logical objects that the database system 120 recognizes, so that content generated by the AI/ML model 132 appropriately maps identifiers and other terms in a custom instruction to the correct portions (e.g., metrics, attributes, columns, tables, etc.) of result data 176 or data from a corresponding data set 122a when the AI/ML model 132 generates the supplemental content 140.

The AI/ML service provider 130 can be a server system or cloud computing platform that provides access to one or more AI/ML models 132, such as LLMs. The computer system 110, the database system 120, and the AI/ML service provider 130 may be implemented as separate systems or may be integrated in a single system. For example, the AI/ML service provider 130 can be a third-party service or can be managed and operated by the same party as the computer system 110 and/or the database system 120.

The computer system 110 can store and provide access to various document 126. These documents 126 may respectively draw content from different data sets 122a-122n, and the documents 126 can be dynamic to adjust their elements, including visualizations, as the content of the associated data sets 122a-122n change. The documents 126 can be files, web applications, web pages, dashboards, reports, or other types of documents. The documents 126 can each include settings, metadata, or configuration data that specify the behavior of the documents 126. For example, for each document 126, the document creator or another editor can specify an instruction to be used for generating supplemental content. The stored instruction can include text that can be used as an instruction or text prompt to an LLM, or can serve as a template or source of text for formulating an instruction or text prompt to an LLM. The creator or editor for a document can specify different instructions to be used for different documents, as well as for different sections, pages, or elements (e.g., individual visualizations) of a document, allowing fine-grained control in advance over the type of AI/ML model content that will be generated later for viewers of a document.

Different users have access to different datasets 122a-122n and documents 126, depending on their roles, permissions, etc. The user 105 authenticates to the computer system 110, so that the user's identity is determined, the user's permissions can be determined, and the user 105 initiates a session for interacting with the computer system 110.

In the example of FIG. 1, in stage (A), the client device 106 displays a view of the document 126a, with content derived from the data set 122a. The current view of the document 126a shows a page of a dashboard with various types of content, e.g., text, images, visualizations, and so on. The computer system 110 generated the content shown in the document 126a based on result data 176, which the database system 120 provided from a stored data set 122a. For example, as part of loading the document 126a and serving it to the client device 106, the computer system 110 requested the result data 176 from the database system 120, received the result data 176 (e.g., as a subset of or results selected or generated from the stored data set 122a), and provided content based on the result data 176 (e.g., a visualization of the result data 176) to the client device 106 over the network for display in the document 126a. The result data 176 represents data processing results which was obtained from the data set 122a, for example, according to SQL statements, filters, aggregations, or other parameters specified in the document 126a.

After the document 126a view is shown, the user 105 triggers the generation of supplemental content or enhancement data by interacting with the user interface element 128, which is shown on the user interface of the document 126a (e.g., as part of the document, as an overlay, in an add-on component or sidebar, etc.). For example, the user 105 can interact with the user interface element 128 with a mouse click, a touchscreen press with a finger, a vocal command to the client device 106, or another manner. In some cases, the request for supplemental content or enhancement data can be triggered in other ways. For example, the computer system 110 can determine that the document 126a includes a setting that supplemental content is provided each time the page or document 126a is initially loaded. Thus, the computer system 110 can initiate the creation and presentation of the supplemental content for the document 126a as part of the initial loading of the document 126a on the client device 106. In another example, the computer system 110 can determine that a particular document includes a setting that supplemental content is provided to or is refreshed the client device 106 each time values in the source data set 122a change (or at least change in a way that would affect the current view). If the computer system 110 determines a change of the data in the data set 122a, then the computer system 110 can automatically generate new supplemental content based on the updated data set 122a and provide the updated document content and the newly generated supplemental content to the client device 106 for display.

When the user interacts with the user interface element 128, the client device 106 generates a request 170 for the computer system 110 to provide supplemental content to display in or with the document 126a.

In some implementations, the document 126a is a dynamic document that changes content when the underlying data in the data set 122a changes. The computer system 110 can refresh the result data 176 when the data set 122a changes, and accordingly, refresh the text, images, and/or visualizations in the document 126a when the data set 122a changes, or when the document 126a is re-loaded or re-opened.

In stage (B), the client device 106 transmits the request 170 to the computer system 110 over the network 102. The request 170 can include various types of information that describe the state of the current view of the document 126a (e.g., which page, section, visualizations, are in view), as well as the scope of data that the user is interested in or is interacting with (e.g., current filter settings applied, which elements are selected by the user, etc.). This information in the request 170 provides information that facilitates the computer system 110's generation of supplemental content for the particular document 126a, and for the particular view and state of the document 126a as currently experienced by the user 105. For example, the generated request 170 can include a session identifier for the current session of viewing the document 126a, a document identifier for the document 126a, a page identifier for the currently viewed page, a user selection status (e.g., indicating if any user interface elements have been selected or highlighted, and identifiers for selected elements), a client device identifier for the client device 106, and other data. In some implementations, the generated request 170 include an instruction typed by the user 105 in a chat box on the document 126a.

The session identifier can represent a unique identifier that computer system 110 assigns for the current session of the client device 106 providing the document 126a, or more generally of interacting with the computer system 110 based on the authentication of the user 105. The document identifier can represent a number, a value, an index, or another data type that identifies the document 126a. The page identifier can represent a number, a value, an index, or another data type of a portion of the particular document currently displayed by the client device 106. The user selection status can include an identifier or element index value that specifies an element that is currently selected (e.g., highlighted or is being interacted with) by the user 105 in the document 126a. For example, the client device 106 can identify one or more selections made by the user 105, e.g., that two specific visualizations shown in the document 126a were selected by the user at the time the user interacted with the control 128, and the client device 106 can provide that information to the computer system 110. The client device identifier can include data that identifies the client device 106 that transmitted the request 170, e.g., a MAC address, an IP address, or other identifying information.

In stage (C), the computer system 110 identifies the scope of data that is appliable for the current view of the document 126a, as indicated by the request 170 received over the network 102. The computer system 110 then obtains the result data 176 corresponding to this scope of data. For example, if the user interface on the client device 106 shows a specific page of the document 126a, or if the user has selected a specific visualization, the computer system 110 retrieves the result data 176 (e.g., data processing results) that are represented in or were used to generate those portions of the document 126a.

The computer system 110 extracts data from the request 170 to retrieve, for example, the session identifier, the document identifier, the page identifier, the user selection status, the client device identifier, and other data. With this information, the computer system 110 can match the request 170 with the appropriate document 126a that the computer system 110 (or in some cases another system) is serving to the client device 106, as well as the particular portion(s) of the document 126a being displayed to or interacted with by the user 105.

With the information in the request 170, the computer system 110 determines the data context for the current view of the document 126a. The data context can represent a limited or targeted scope of the data set 122a that is relevant to the current view of the document (e.g., the data represented in the currently displayed page or visualizations). For example, the computer system 110 can use a page identifier to identify the page of the data set 122a that is being shown in the user interface on the client device 106, so the computer system 110 can focus in on the result data 176 that corresponds to the elements of that page. The computer system 110 can analyze the user selection status to determine which user interface element of the document 126a, if any, were selected at the time the user 105 interacted with the control 128. If so, then the computer system 110 can limit the data scope to the selected elements on the document 126a, so that other non-selected items are excluded from the processing to generate supplemental content. If the user 105 has selected a specific visualization, e.g., a chart, the computer system 110 can identify and access the specific portions of the result data 176 that are shown in the selected chart. The computer system 110 identifies the result data that is represented in the document components selected by the user, and the computer system 110 analyzes that result data to generate the supplemental content. Then, the computer system 110 will provide the supplemental content to the client device 106 specified by the device identifier.

When the computer system 110 identifies the data scope that is applicable for the current view of the document 126a, the computer system 110 retrieves the corresponding result data 176. Rather than attempt to extract data from the rendered elements of a user interface, the computer system 110 accesses a copy of the result data used to generate the user interface elements. When the computer system 110 serves the document 126a to the client device 126, the computer system 110 can already have the result data 176 stored (e.g., cached) in temporary storage, and so the computer system 110 can access the data here without the need to make a request to the database system 120. In other cases, the request 170 may include result data 176 that was extracted in the document 126a content at the client device 106. The visualizations or other content can include embedded data or can receive result data 176 for a server, so that the visualizations can be filtered or otherwise adjusted, so that data is available to provide to the computer system 110 if needed. If necessary, the computer system 110 can make a request to the database system 120 to again generate the result data 176 (e.g., by processing a SQL statement or other data processing instructions), although this is often not needed and is preferably omitted to reduce latency and load on the database system 120.

In stage (D), the computer system 110 can perform analysis on the result data 176 for the scope of data determined to be relevant to the current view of the document 126a. The computer system 110 can perform any of various types of analysis to identify, relationships, statistical measures, and other information about the result data 176, so that the computer can use the analysis results 144 to guide the AI/ML model 132 in generating supplemental content to provide along with the document 126a. The analysis performed can be data processing operations that the AI/ML model 132 is not trained to perform, or is not capable of performing deterministically or as accurately as a dedicated algorithm or model. In addition, in some implementations, the analysis can include types of operations or analysis that are different from or go beyond the processing that is requested in a stored instruction 146 associated with the document 126a (e.g., defined by the document creator or an administrator) or a request from the user 105 (e.g., a prompt to a chatbot). As a result, the computer system 110 can generate analysis of the result data 176, for later use by the AI/ML model 132 in generating output, that is not requested by the document 126a or a user.

The computer system 110 can use various models 142 or algorithms to perform its analysis and generate result data 144. In the example, the models 142 include a trend analysis model, a key factor model, and a forecasting model. The computer system 110 may also include other mathematical and ML models to analyze the result data 176.

The trend analysis model can analyze the result data 176 to identify patterns and/or trends in the result data 176, such as determining behavior or changes with respect to time or other factors (e.g., geography, category, etc.). For example, the trend analysis model can determine whether the values in the result data 176 increase, decrease, remain constant, fluctuate in a range, or have another pattern. In general, the trend analysis can determine direction or tendencies of the result data 176, as well detect anomalies or outliers that deviate from a larger trend. The trend analysis model can output analysis results 144 in any of various forms, such as percentages (e.g., a percentage change between two points in time), a direction of change (e.g., increase or decrease), ranges, and so on.

The key factor model can analyze the result data 176 to assess the relative importance or impact of different items on performance or outcomes. For example, the analysis can analyze relationships among the variables or components of the result data 176 to determine which types of data are most correlated with, predictive of, or causative of certain outcomes. In general, the analysis can assess the derived importance of independent variables on dependent variables, to see which independent variables have the highest level of influence on the dependent variables. In some implementations, this involves assessing the relative influence of values of different attributes in the result data 176 (or the data set 122a more generally) on values of metrics in the result data 176.

The forecasting model can analyze the result data 176 to predict likely extensions to sequences or series of data. For example, the forecasting model can use the patterns in the result data 176 to predict future events, future trends, or future outcomes. The forecasting model can leverage statistical analysis, patterns, and trends to generate projections of future events, trends, or likelihoods.

In stage (E), the computer system 110 generates and sends a request 172 for narrative content to the AI/ML model 132. The request 172 can include or be generated based on a stored instruction 146 that was previous associated with the document 126a (e.g., before it was loaded by or displayed to the user 105 in the current session). The instruction 146 can be text that the creator of the document or an administrator designated to define the content and format of supplemental content that is provided with the document 126a. The instruction 146 can reference specific document elements (e.g., specific charts or graphs), specific data objects (e.g., particular attributes, metrics, etc.), statistics, relationships, or other data to include. The document 126a itself, or associated metadata or settings, can store the instruction 146. In addition, different instructions can be specified and stored for different portions of the document 126a (e.g., with separate instructions for different pages, different visualizations, etc.). As a result, the computer system 110 can access the settings or metadata for the document 126a to identify and use the particular instruction 146 that is designated for the particular state of the document view at the client device 106 (e.g., the particular page shown, a particular visualization that is selected, etc.).

The request 172 can combine the instruction 146 (which was defined in advance) with the result data 176 and corresponding analysis results 144 that are determined for the current state of the document 126a. This combination allows a document creator's instruction 146 for generating narrative description to produce supplemental content that is accurate and up-to-date even if the values in the data set 122a change (e.g., when additional data has been added), and for the narrative description to correspond to the current state of the document, even for particular selections by the user 105 or filter settings applied by the user 105.

The request 172 includes information to cause the AI/ML model 132 to provide a narrative (e.g., description, explanation, interpretation) of items shown in the current view of the document 126a. If the user 105 has selected specific items (e.g., a specific chart), then the request 172 is tailored to focus on the selected items. The computer system 110 guides the AI/ML model 132 to provide a description that corresponds to and is accurate for the current view presented to the user 105 by providing the result data 176 for the data scope that the computer system 110 has identified. As discussed above, this includes any user selections or filter settings that are not part of the document 126a, but which the user 105 has applied after loading the document 126a. By providing the result data 176 of the appropriate scope, as well as analysis results 144 that indicate significant features of the result data 176, the computer system 110 can assist the AI/ML model 132 to generate high-quality output that is accurate and coordinated with the current state or current view of the document 126a.

In general, the request 172 can be used to cause the AI/ML model 132 to produce enhancement data or supplemental content that provides narrative text that indicates the most important or prominent relationships, features, and values in the current view of the document 126a. Often, the meaning or significance of visualizations and other content is not apparent to the user 106. Many people may not understand the graphs and charts that are presented to them, or may miss the high and low values or other aspects. In addition, many documents have a large number of items displayed at once, making the most important information difficult to identify at times. By allowing the document creator (or editor) to specify the instruction 146 or text prompt for an AI/ML model 132 to use for a document, and to adjust it for different sections or items in a document, the system 110 can provide supplemental information that is useful and indicates the most important features of the document.

The request 172 can include the instruction 146, the result data 176, the analysis results 144, and a data schema or data model 149 for the data set 122a from which the result data 176 is derived. The computer system 110 can provide or transmit the request 172 to the AI/ML service provider 130 over the network 102. The AI/ML service provider 130 can provide access to one or more AI/ML models 132, such as LLMs.

In some implementations, the instruction 146 includes one or more predefined instructions for generating the supplemental content. For example, the one or more predefined instructions can include text instructions for generating the supplemental content associated with a particular document, associated with a particular page of a document, or a portion of a page of the document. For example, the predefined instructions can include instructions to generate an executive summary of the analysis results 176. The stored instruction may specify a format for how the supplemental content is to be structured (e.g., a bulleted list, table, graph, or other data types), as well as formatting (e.g., a font size, italics, bold, colors, and other). The predefined instructions can also include other formatting information, e.g., a color-coding scheme for portions of the supplemental content. The computer system 110 can provide interfaces (e.g., a web page, an application programming interface (API), application functionality, etc.) for an editor or administrator to create and edit the stored instruction 146.

The request 172 can include a data model 149 that describes the data objects (e.g., attributes, metrics, etc.) mentioned in the result data 176. The various other types of information in the request 172 may include references to specific data objects, such as the names or identifiers of specific attributes and metrics. The data model 149 provides the information about the set of valid data objects and their identifiers, so the AI/ML model 132 can resolve those references. For example, the instruction 146 may refer to an attribute “Month” and a metric “Inventory,” where these are data objects in the data set 122a and for which data is included in the result data 176. If the instruction 146 specifies to indicate the highest and lowest value of the “Inventory” metric (whether through a unique identifier or simply text keywords), the information in the data model 149 will allow the AI/ML model 132 to map the reference to the set of values for the “Inventory” metric in the result data 176.

In some implementations, the functions described in stages (C) through (E) can be performed by an orchestration layer in the computer system 110. The orchestration layer may divide the tasks or functions from stages (C) through (E) to different agents. In this manner, each agent may perform the tasks for these respective stages in parallel that reduces overall processing time and improves management of the various tasks.

In stage (F), the AI/ML service provider 130 receives the request 172 and generates output. The AI/ML service provider 130 can extract the data from the request 172, e.g., extract the stored instruction 146, the result data 176, the analysis data 144, and the data schema or data model 149. The AI/ML service provider 130 can provide the extracted data as input to one or more AI/ML models 132 to generate the supplemental content requested (e.g., a narrative description according to the instruction 146, based on the result data 176 and the analysis 144, with data objects interpreted and resolved using the data model 149). In response, one of the AI/ML models 132 generates AI/ML model output 173 that includes the narrative or supplemental content as requested.

In some implementations, the AI/ML models 132 can process the data from the request 172 to interpret the meaning of these data types. Generally, an LLM seeks to interpret and generate a narrative, e.g., human readable text, by analyzing various patterns across vast amounts of data. The LLM can generate a coherent and contextually appropriate narrative of the extracted data from the request 172. In some cases, the LLM can provide summaries of the extracted data from the request 172. In some cases, the LLM can generate a response in a designated language specified by the request 172 (e.g., a language of the user 105), e.g., English, French, Spanish, etc.

The LLM can create the AI/ML model output 173 with layout, formatting, or other characteristic according to the data provided in the request 172. For example, the LLM may color code certain portions of the text, generate the text with a directed emotional tone, personalize or tailor the generated text according to the preferences of the user 105 authenticated with the computer system 110. In some cases, the LLM can use the data model 149 to interpret the meaning of data objects or data metrics in the instruction 146. This can include mapping identifiers to data objects or data values in the result data 176 or analysis results 144, or potentially also mapping terms or keywords to data objects and data values.

The AI/ML service provider 130 transmits the AI/ML model output 173 to the computer system 110.

In stage (G), the computer system 110 generates and transmits response data 182 to the client device 106 over network 102, where the response data 182 can include or be derived from the AI/ML model output 173. In some cases, the computer system 110 can use the client device identifier, session identifier, or other information in the request 170 to direct the response data 182 to the appropriate client device 106.

The computer system 110 can perform validation on the AI/ML model output 173 before providing the text to the client device 106. The computer system 110 can validate or clean any HTML, JavaScript, Python, SQL, or other content from the AI/ML model output 173, to name some examples. For example, the computer system 110 can determine whether the AI/ML service provider 130 generated the narrative consistent with the criteria provided in the request 172. In addition, the computer system 110 can validate any markup language content (e.g., HTML) or code (e.g., JavaScript code) provided in the AI/ML model output 173 to verify that it is functional and does not present a security risk.

The computer system generates response data 182, which can include text, images, markup language content, code, etc. The response data 182 is provided to be displayed with (e.g., alongside, in an overlay, etc.) the document 126a shown at the client device 106.

In stage (H), the client device 106 receives and displays the response data 182. The client device 106 can present the response data 182 as supplemental content 140 for the current view of the document 126a.

The system can repeat the process discussed above for stages (A) through (H) each time user 105, client device 106, or computer system 110 triggers the creation of new supplemental content to be displayed on the client device 106. Additionally, the process of stages (A) through (H) can be performed independently and in parallel to provide different supplemental content for each of multiple different client devices that each have their own documents loaded and have their own document views displayed, with different filters and selections applied and different content in view.

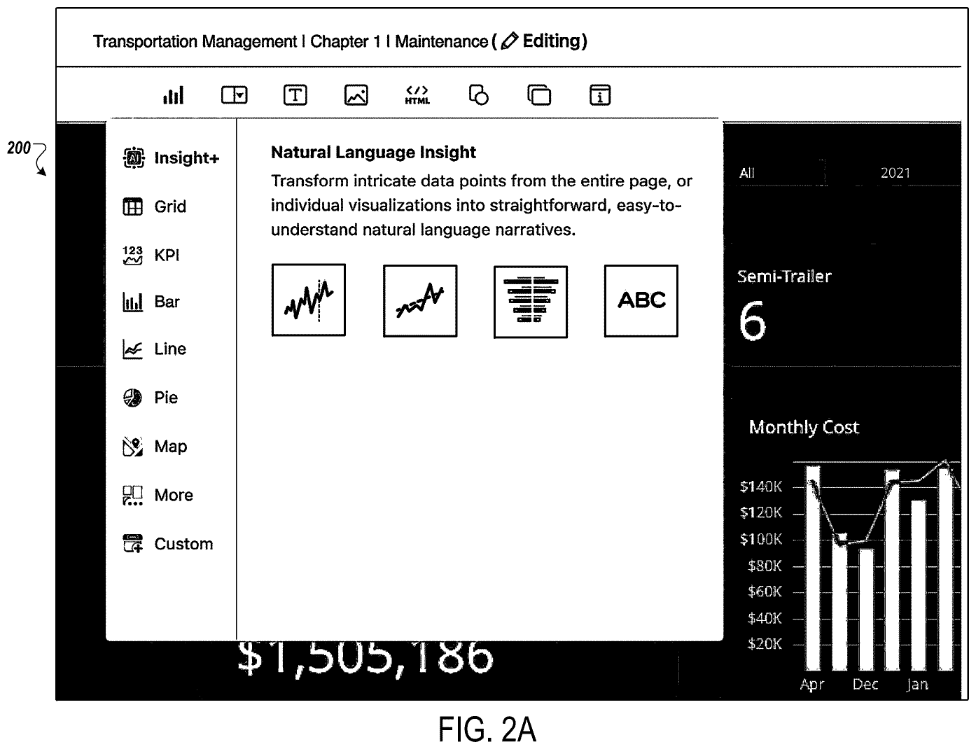

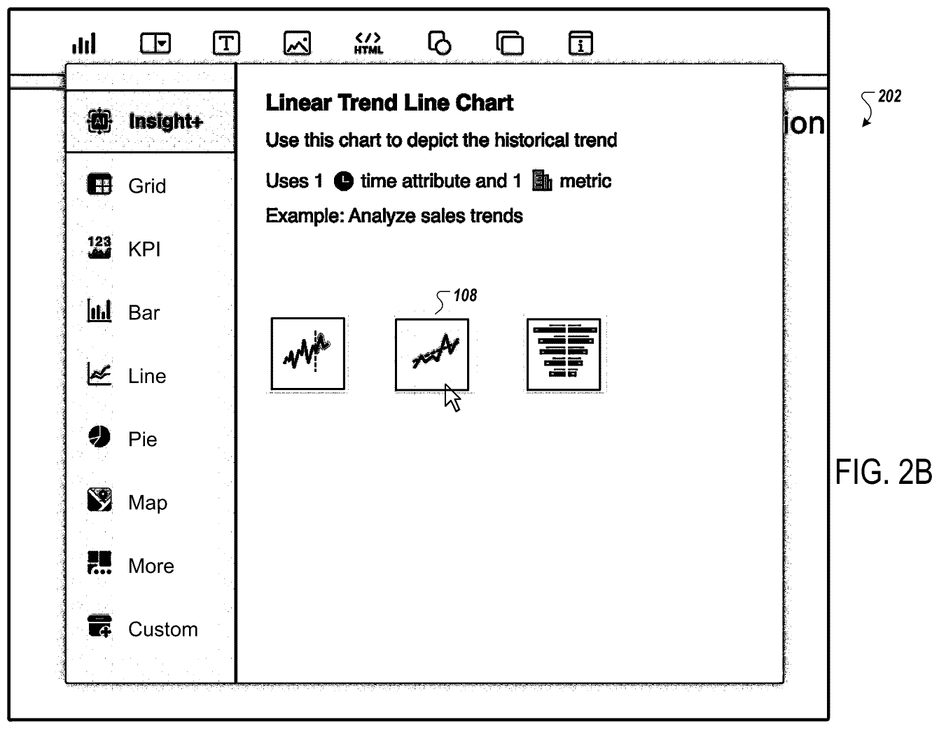

FIG. 2A is a diagram showing a user interface 200 that illustrates an example of a document that includes supplemental content to enhance data shown in the document. A computer system, such as computer system 110 of FIG. 1, can generate and provide supplemental content and a document to a client device, which presents the same on its interface.

In some implementations, the client device can display interactive features for generating supplemental content from the document. As shown in the example of FIG. 2A, the diagram 200 include a natural language insight GUI overlaid on a document. The natural language insight GUI enables the user to select a type of supplemental content that the user selects to view. For example, the natural language insight GUI describes its function is to “Transform intricate data points from the entire page, or individual visualizations into straightforward, easy-to-understand natural language narratives.” In further detail, the natural language insight GUI provides various types of supplemental content presentations. This can include, for example, a data point selection, a line regression analysis, a bar chart, or a narrative description, each of which may be selectable by the user interacting with the client device.

Underneath the natural language insight GUI, the client device displays the document. The document can include various data types. These various data types can include, for example, visualizations, text, images, tabs, pages, a pie graph, a bar chart, a line chart, a table, a grid, a scatter plot, or other types of plots. Each data type can also include distinctive characteristics that further reveal differences between the data types shown in the visualization. For example, the distinctive characteristics can include different colors, different textures, different line thicknesses, different styles, and other characteristics to represent the different data types. In this manner, a user or administrator reviewing a particular document can quickly identify distinctions between the data types shown for that visualization. The client device may also display a legend that annotates the data being displayed. For example, the legend can annotate the data type with a name, a color palate for that data type, and other characteristics to identify the data type.

In some implementations, the client device can receive a selection from the user to generate supplemental content. As mentioned, the user can select one of the components on the natural language insight GUI, which triggers the client device to request for supplemental content of the currently displayed document or selected portions of the document from a computer system. The requested supplemental content may be displayed in the form of narratives, additional visualizations, or characterizations, to name some examples.

The computer system can generate and provide supplemental content that allows a user review straightforward, easy to understand narratives or additional visualizations of the content shown in the displayed document. In this manner, a user or administrator can receive interpretations of the content shown in the document that may otherwise go unnoticed without additional insight. The client device can display the generated supplemental content on the same user interface that displays the content.

As will be further shown below, the enhancements may be overlaid on the same user interface. Moreover, the client device can display the generated supplemental content in a movable graphical user interface that enables an administrator to move the supplemental content to a preferred location on the interface. In this manner, the user can view both the generated supplemental content and the portions of the document that the generated supplemental content is created from for reference.

FIG. 2B is another diagram that illustrates a user interface 202 that illustrates an example of a document that includes supplemental content to enhance data shown in the document. FIG. 2B illustrates a similar natural language insight GUI as the GUI illustrated in FIG. 2A. The diagram 202 shown in FIG. 2B can be displayed on a client device, such as client device 106 illustrated in FIG. 1.

However, in the example of FIG. 2B, the user can select a particular supplemental content presentation, such as the line regression 108. When the user selects the line regression 108 option on the natural language insight GUI, the client device can trigger the creation of supplemental content for a target scope of a document. Moreover, the client device can incorporate additional description into the natural language insight GUI. For example, the additional description can include “Linear Trend Line Chart,” “Use this chart to depict the historical trend,” and “Uses 1 time attribute and 1 metric”. The client device indicates to the user the type of metrics for this particular supplemental content creation, and provides these metrics to the computer system, e.g., computer system 110, for the creation of supplemental content. The computer system can use these metrics to poll data from different data schema/data models and to provide corresponding data to various non-AI/ML models and AI/ML models.

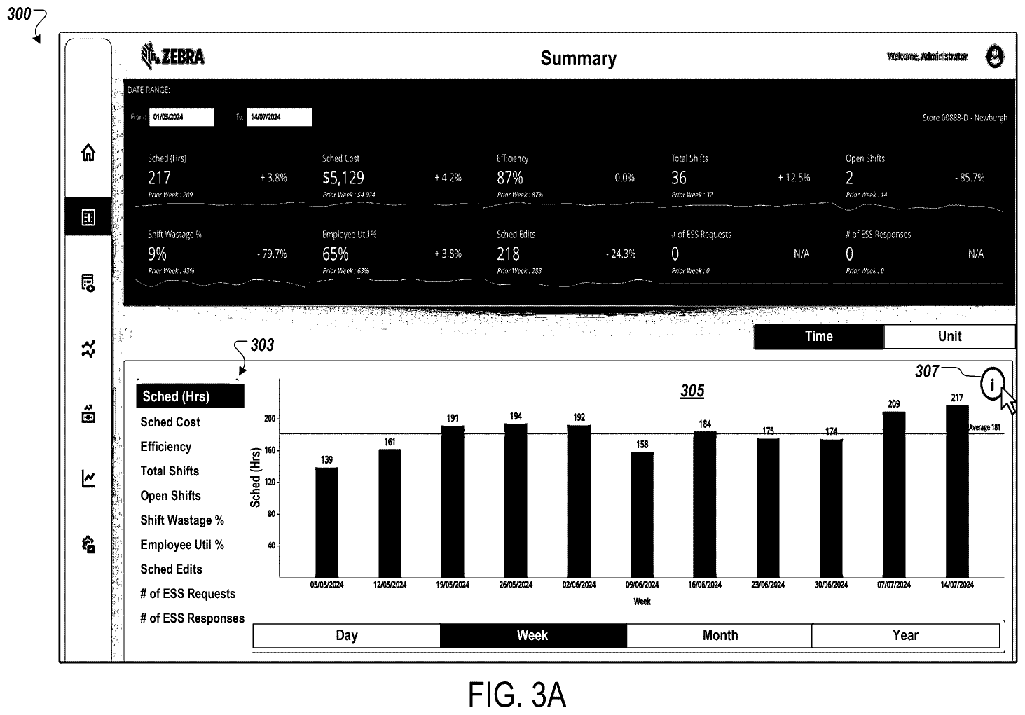

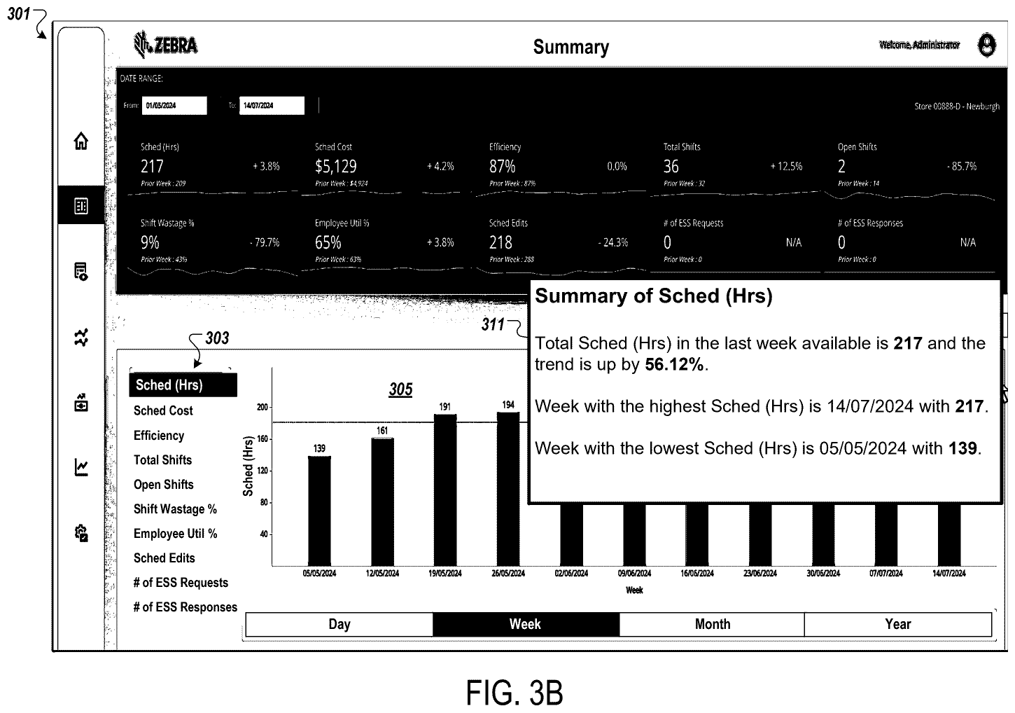

FIG. 3A is a diagram 300 that illustrates an example of a document shown on a client device. The document includes multiple visualizations, e.g., various line graphs, bar graphs, a summary of different data types, and different filters or selectable options 303 to apply for viewing different data in a main viewing pane 305, e.g., “Sched (Hrs)”, “Sched Cost”, “Efficiency”, “Total Shifts”, “Open Shifts”, “Shift Wastage %”, “Employee Util %”, “Sched Edits”, “#of ESS Requests”, and “#of ESS Responses”. In the example, the user has selected “Sched (Hrs)” from among the options 303, and so the visualization in the main viewing pane 305 shows that data.

In some implementations, the diagram 300 includes a control 307, such as a button or icon. A user viewing the document can interact with the control 307 to initiate presentation of additional analysis or description of the document. Depending on the settings for the currently displayed document or an application that displays the document, the client device can trigger the generation and/or display of enhancement data or supplemental content in response to the user interacting with the control 307. In response to the user interacting with the control 307, the client device requests supplemental content for the displayed document from the computer system 110. The computer system 110 can generate supplemental content according to a custom instruction (e.g., a set of predefined instructions) associated with the currently displayed document, the application showing the document, or the selected data shown on the document. In this case, because the user has selected a particular data series, for “Sched (Hrs),” supplemental content will be generated based on that user-selected set of data.

FIG. 3B is a diagram showing an example of a user interface 301 that shows a document and supplemental content 311. The user interface 301 is shown after the user interface 300, as a continuation of actions and results from the example of FIG. 3A. For example, in response to the user selecting the control 307 on the interface 300, the client device triggers the generation and/or display of supplemental content. The user interface 301 shows the resultant supplemental content 311 or auto narrative describing the content shown in the document generated by the computer system and provided to the client device for display. For example, the supplemental content 311 includes a narrative description of the relevant data shown in the bar graph according to the “Sched (Hrs)” filter. The resultant supplemental content 311 describes “Summary of Sched (Hrs)”, “Total Sched (Hrs) in the last week available is 217 and the trend is up by 56.12%.”, “Week with highest Sched (Hrs) is Jul. 14, 2024 with 217.”, and “Week with lowest sched (Hrs) is May 5, 2024 with 139.”

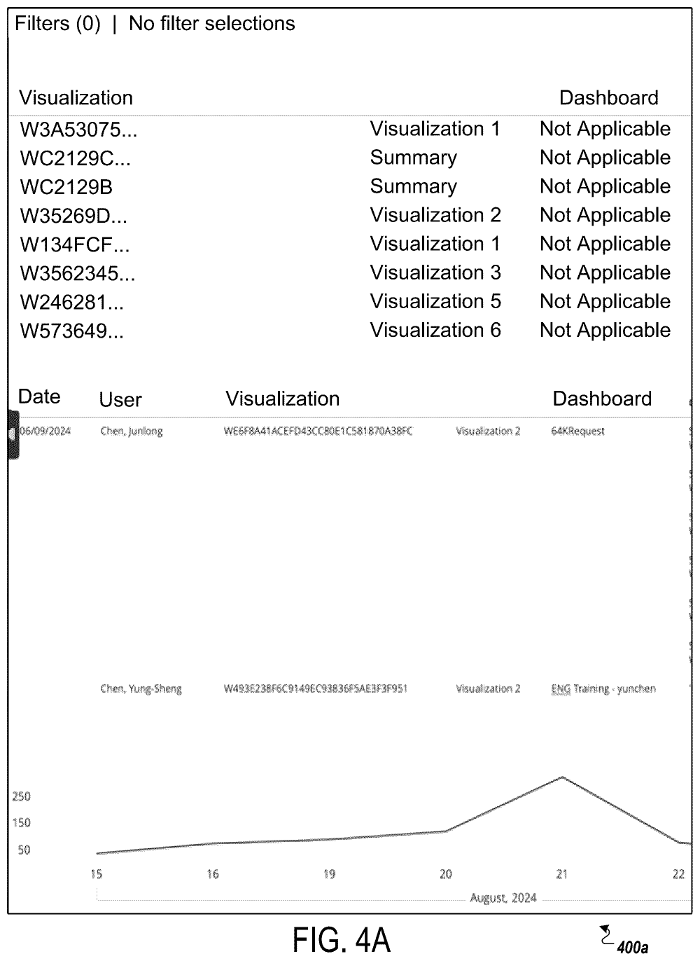

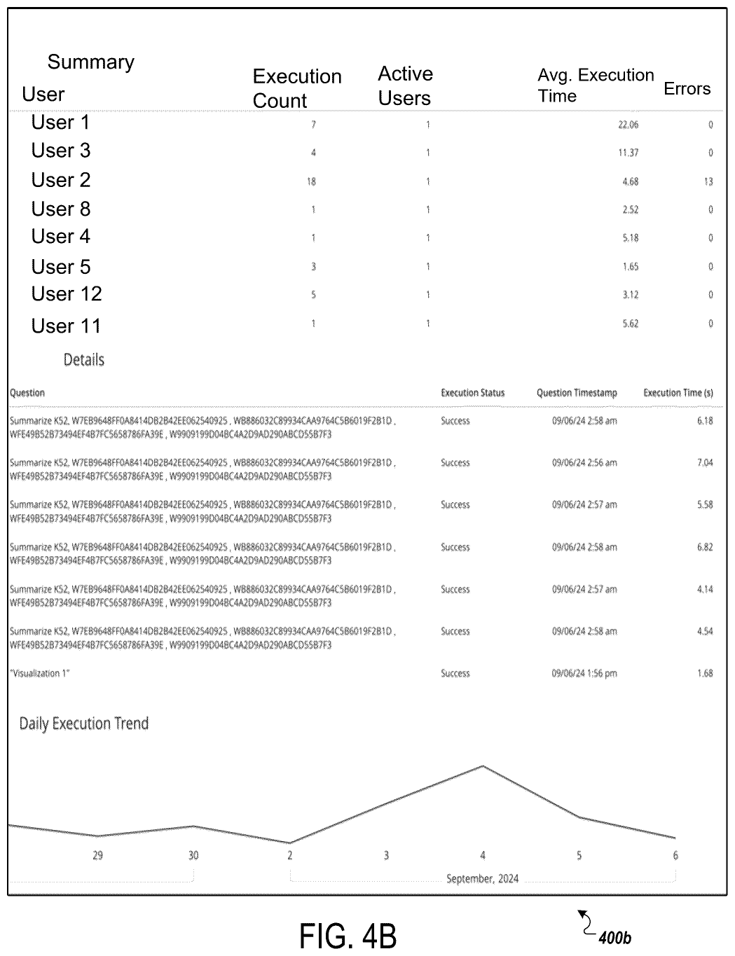

FIG. 4A is a diagram 400a that illustrates an example of metadata for creation of the supplemental content. In further detail, the diagram 400a illustrates metadata that represents data displayed on a document and data associated with a user viewing the document. For example, identifiers for each of the visualizations and summaries shown in the document, descriptions of the visualization types, and data identifying which dashboard the visualizations are displayed to. Moreover, the diagram 400a illustrates that a particular user, e.g., Juniong Chen, requested for supplemental content for a particular visualization on Jun. 9, 2024 from a particular dashboard. Similarly, another user, e.g., Yung-Sheng Chen requested for supplemental content for a particular visualization on another dashboard.

FIG. 4B is another diagram that illustrates a user interface 400b that illustrates an example of metadata for creation of the supplemental content. FIG. 4B is a continuation of the metadata shown in the example of FIG. 4A. Continuing with the discussion from FIG. 4A, FIG .4B illustrates the different users accessing and/or interacting with different visualization types, the corresponding average execution times. The details of the interactions further include, for example, various identifiers that represent the instruction submitted by the user for generating the supplemental content. The various identifiers can include different data objects, different metrics, and other descriptions. The diagram 400b of FIG. 4B illustrates identifiers, e.g., “W7EB9648FF0A8414DB2B42EE062540925”, and others that represent the different data objects, different metrics, and other descriptions, referenced in the instruction provided by the user. The diagram 400b of FIG. 4B additionally illustrates the result of the execution of the request for generated supplemental content, e.g., “Success” or “Fail”, a timestamp for the receipt of the instruction, and an amount of time taken for the creation of the generated supplemental content in response to receiving the instruction.

In some implementations, the computer system can generate predictions for various users using the underlying metadata. For example, the computer system can store the underlying metadata for a particular user or users in the knowledge base. The computer system can train the forecasting model to predict future supplemental content for a particular user based on previously requested instructions. Thus, when a particular user authenticates with the computer system and requests for an initial load of a document, the computer system can provide the forecasting model with data identifying a user and data identifying the document to be loaded. The forecasting model can produce or predict generated supplemental content to be shown on the document to be loaded for that user based on that user's previous instructions. In this manner, the computer system can present generated supplemental content for the user without the user having to request for the generated supplemental content.

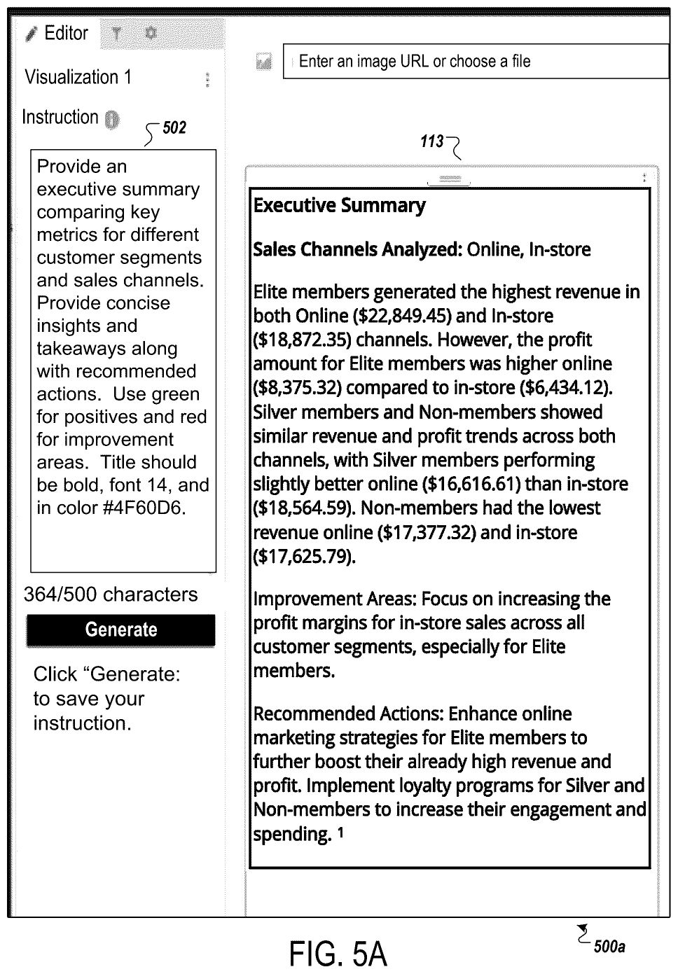

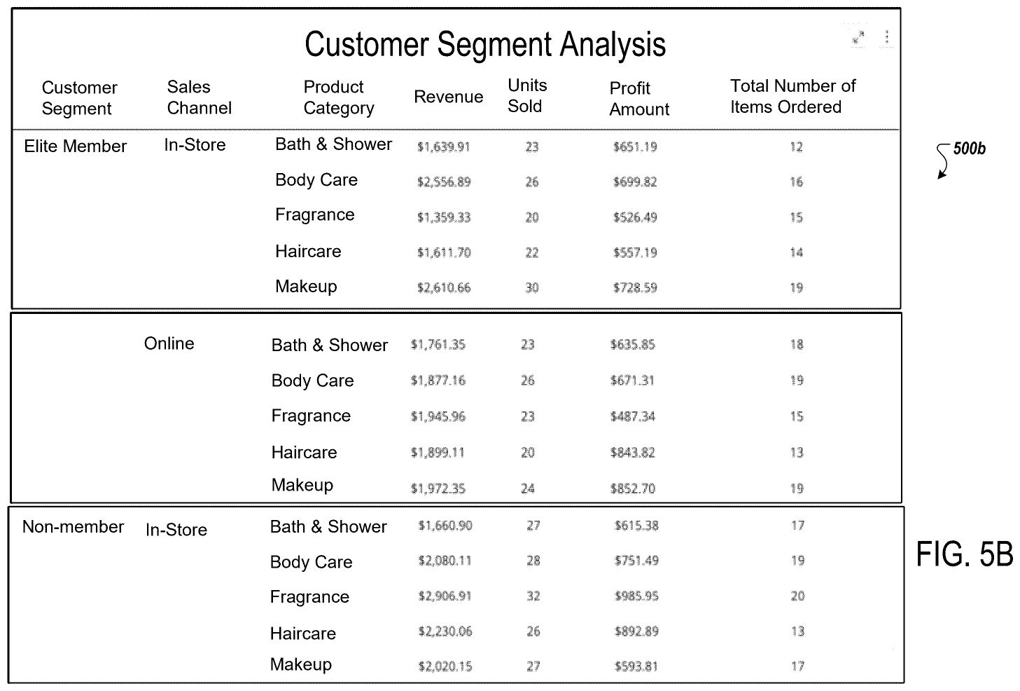

FIGS. 5A-5B together show an example of a user interface, with component 500a on the left side and component 500b on the right side. The user interface composed of components 500a-500b shows an interface where a user creating or editing a document can generate instructions to be saved an associated with a document, so that viewers of the document can later receive dynamically-generated supplemental content without having to input any query or text prompt. In further detail, an input field 502 is provided for an administrator or user to enter a custom instruction, to define a set of predefined instructions for generating supplemental content for a specific document or specific portions of the document. The custom instruction may reference various data objects (e.g., attributes or metrics) in the applicable data model, as well as reference specific visualizations or other elements of the document being edited. The creator interface provides the user a preview showing an example of the generated supplemental content 513 would see according to the predefined set of instructions executed at the computer system. When the system later generates supplemental content for that particular document, the system can retrieve the actual values corresponding to the current state of the object(s) referenced in the custom instruction and display that information.

For example, as illustrated in the diagram 500a of example 5A, the set of predefined instructions include “Provide an executive summary comparing key metrics for different customer segments and sales channels. Provide concise insights and takeaways along with recommended actions. Use green for positives and red for improvement areas. Title should be bold, font 14, and in color #4F60D6.” The set of predefined instructions can be saved in the computer system in response to a user selecting the “Generate” button on the interface 500a of FIG. 5A. Moreover, the generated supplemental content 113 shown in the interface 500a of FIG. 5A illustrates an example of how the supplemental content would look to a user according to the set of predefined instructions.

FIG. 5B is another diagram that illustrates a user interface 500b that illustrates an example of a creator interface for generating and/or displaying supplemental content. The example of FIG. 5B is a continuation of the diagram 500 shown in FIG. 5A. The generated supplemental content 113 created and displayed in FIG. 5A uses content shown in the document from FIG. 5B. For example, the document shown in FIG. 5B titled “Customer Segment Analysis” includes customer segment information, sales channel information, product category information, revenue information, units sold information, profit amount information, and a total number of items earned. The client device can provide data representing the content shown in “Customer Segment Analysis” document to the computer system to create the generated supplemental content 513 shown in FIG. 5A.

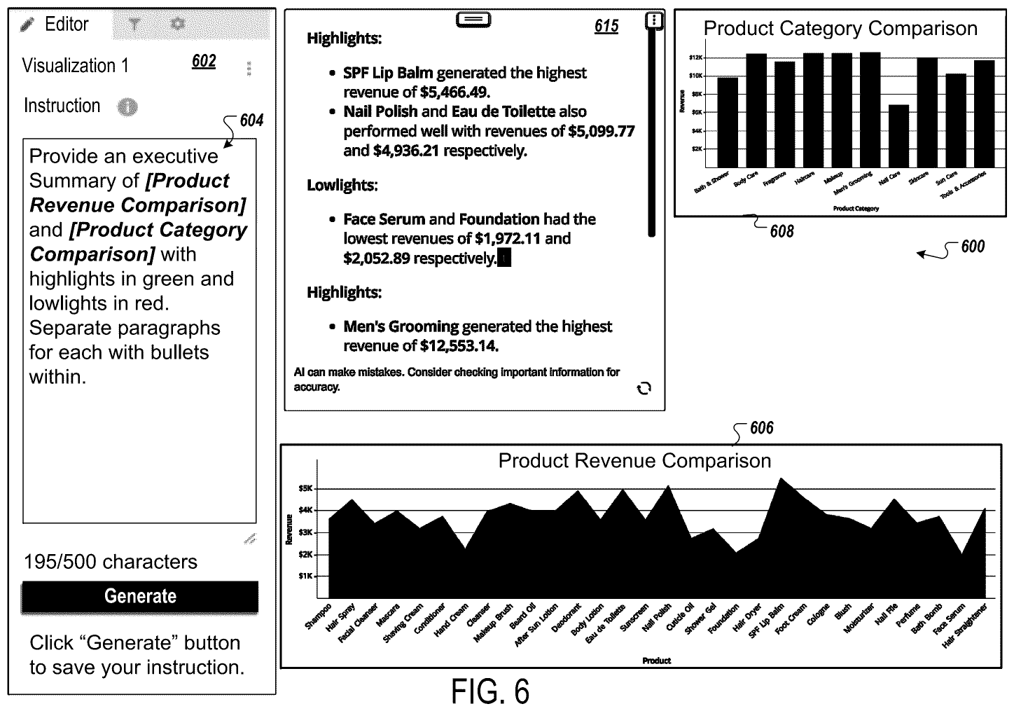

FIG. 6 is another diagram that illustrates a user interface 600 that shows an example of a creator interface 602 for generating and/or displaying supplemental content. The example of FIG. 6 illustrates a set of predefined instructions 604 that include “Provide an executive summary of [Product Revenue Comparison] and [Product Category Comparison] with highlights in green and lowlights in red. Separate paragraphs for each with bullets within.” The set of predefined instructions can be saved in the computer system in response to a user selecting the “Generate” button on the interface 600 of FIG. 6. In the instructions 604, the identifiers “[Product Revenue Comparison]” and “[Product Category Comparison]” refer to specific visualizations 606, 608 in the page of the document currently viewed by the user editing the document. As a result, the instructions 604 are using the visualization object to define the type of data and scope of data that should be summarized. In a similar manner, the instructions can refer to data metrics or data objects in a data model, in addition to or instead of referring to elements shown in the document. The data metrics or data objects can represent quantities or data object that are represented in, or can be derived from, data stored in a data set of database system 120.

The example of FIG. 6 illustrates the resultant supplemental content 615 or auto narrative describing the content shown in the document and displayed at the client device. For example, the resultant supplemental content 615 provides a narrative emphasizing the key features of the “Product Revenue Comparison” graph shown in the GUI below the resultant supplemental content 615. The resultant supplemental content 615 presents the narrative in a structure and in a format dictated by the set of predefined instructions shown in the creation interface or editor mode text box.

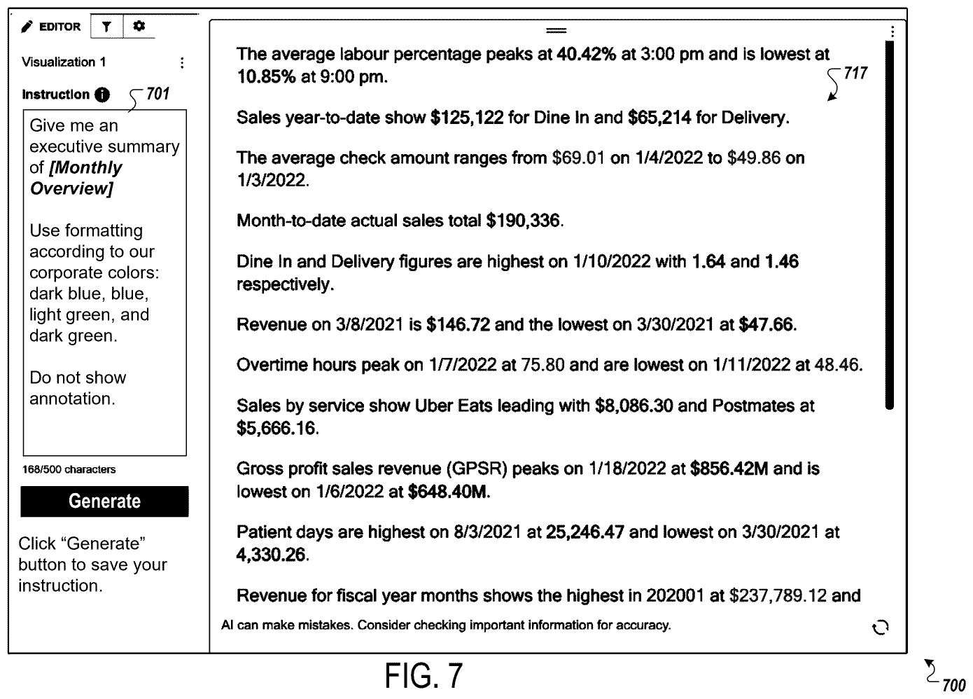

FIG. 7 is another diagram that illustrates a user interface 700 that shows an example of a creator interface for generating and/or displaying supplemental content. In further detail, the user interface 700 includes a text field 701 that enables an administrator to specify a set of predefined instructions. The user interface 700 also provides a preview that illustrates an example of the supplemental content 717 that would be generated based on the current instructions. The predefined instructions include “Give me an executive summary of [Monthly Overview],” “Use formatting according to our corporate colors: dark blue, blue, light, green and dark green,” and “Do not show annotation.” As the user is entering text in the text field 701, the computer system 110 can populate or autocomplete objects that are in the scope of the current page or section of the document. For example, names or other identifiers for visualizations or data objects included or referenced in the current document page can be provided through a drop-down menu, a separate list, autocompletion suggestions, and so on. The generated supplemental content 717 shown in the interface of FIG. 7 illustrates an example of how the supplemental content would look to a user according to the set of predefined instructions created by an administrator.

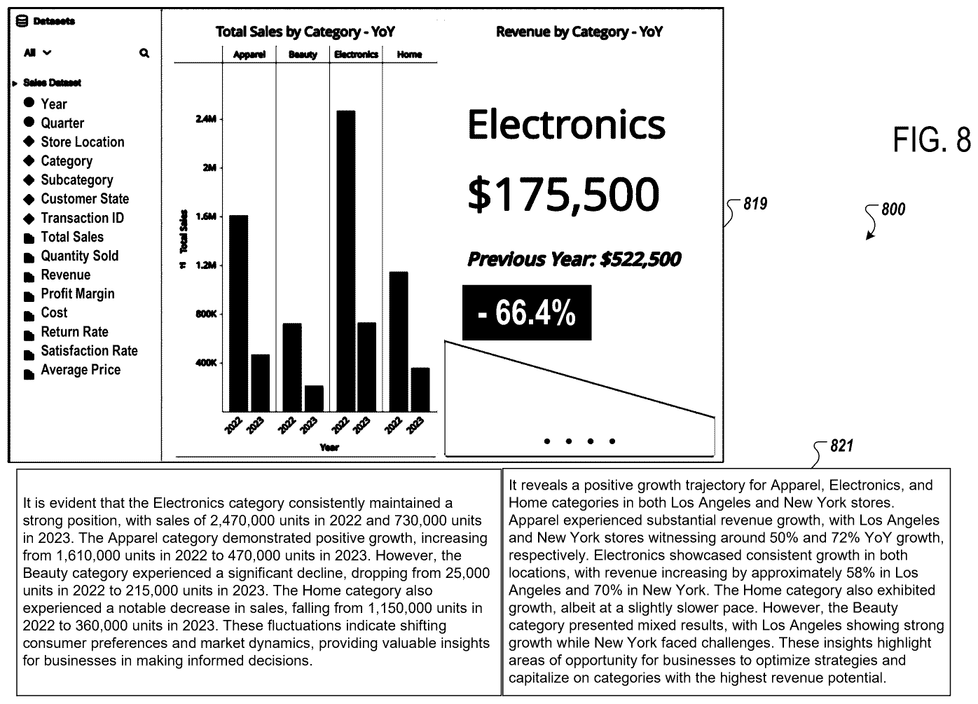

FIG. 8 is another diagram that illustrates a user interface 800 that shows an example of a document and supplemental content shown on the client device. The supplemental content 821 shown on the client device may be generated and displayed in response to the user submitting an instruction, selecting a button on the interface, the computer system loading the document 819 on the client device, or another function. The supplemental content 821 describes in narrative format the content shown in the document 819. In this manner, the user is presented with relevant, enhanced, or supporting information shown in the supplemental content 821 according to the information presented in the total sales by category and the revenue by category displayed by the client device.

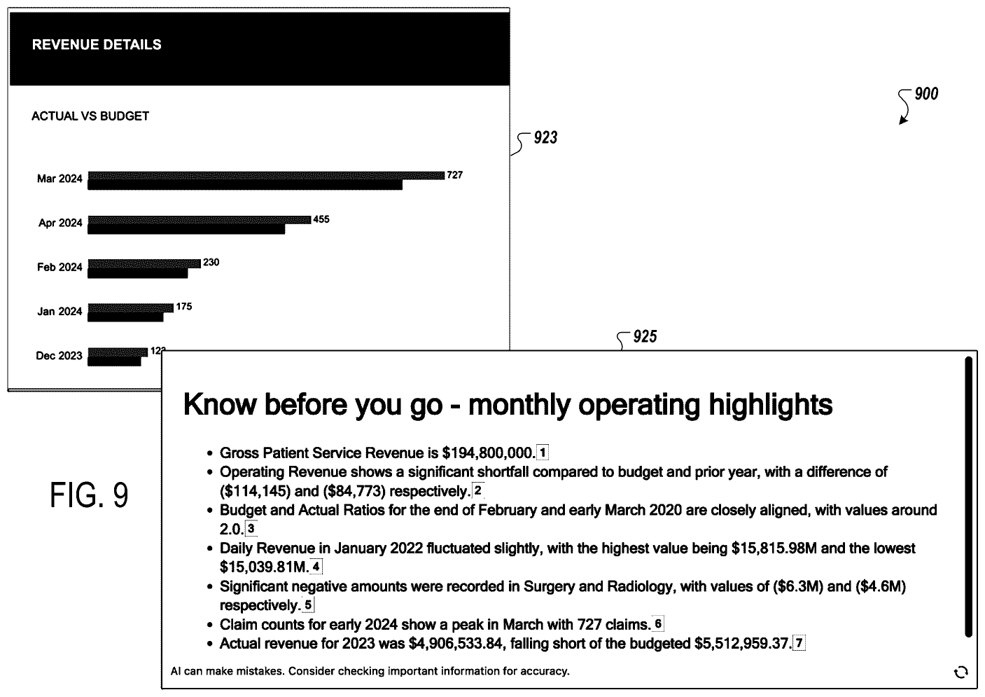

FIG. 9 is another diagram that illustrates a user interface 900 that shows an example of a document and supplemental content shown on the client device. The supplemental content 925 shown on the client device may be generated and displayed in response to the user submitting an instruction, selecting a button on the interface, the computer system loading the document 923 on the client device, or another function. The supplemental content 925 describes in narrative format the content shown in the document 921. The document 921 illustrates a bar graph over the months of December 2023 through April 2024 indicating the actual revenue against budget revenue. The client device can trigger the generation and display of supplemental content 925. Here, the supplemental content 925 recites the content shown in the document 921 in a narrative format—“Know before you go—monthly operating highlights” and so on.

In some implementations, the supplemental content displayed by the client device includes a disclaimer. The disclaimer recites “AI can make mistakes. Consider checking important information for accuracy.” The disclaimer ensures the user is aware that the information produced by the non-AI/ML models and AI/ML models is verified for accuracy. If the user determines the supplemental content produced by the computer system is incorrect, the user can provide feedback to the client device, which provides the feedback to the computer system for retraining the AI/ML models with the corrected information to reduce errors in future iterations.

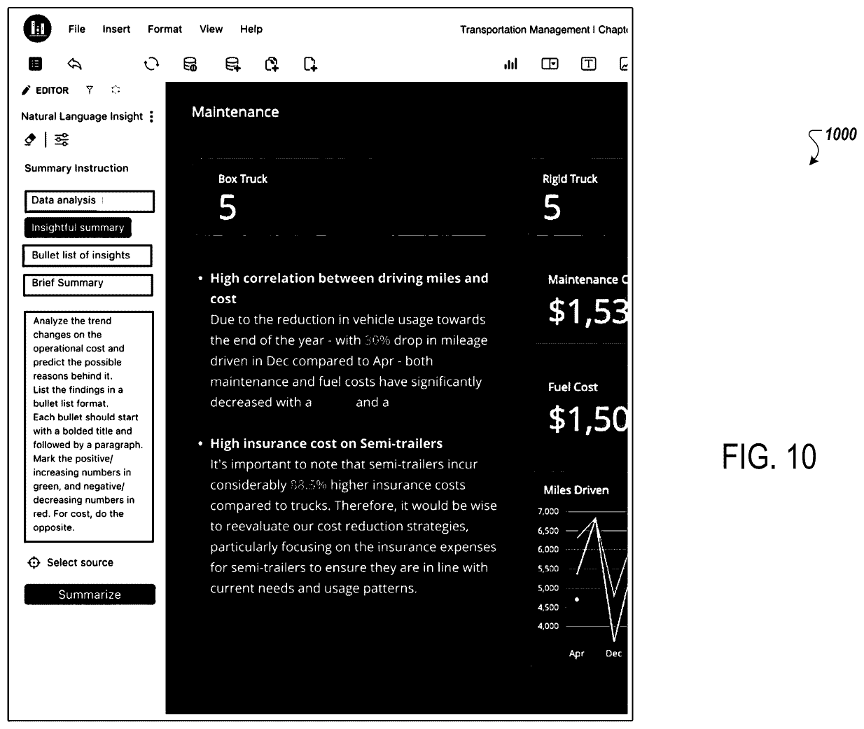

FIG. 10 is another diagram that illustrates a user interface 1000 showing an example of a creator interface for generating and/or displaying supplemental content. The administrator can provide a series of instructions for each option illustrated in the editor panel. For example, the administrator can provide the series of instructions for the “Data analysis” option, the “Insightful summary” option, the “Bullet list of insights” option, and the “Brief Summary” option. In the example of FIG. 10, the administrator selected the “Insightful summary” option and provided a detailed series of instructions. The detailed series of instructions recites “Analyze the trend changes on the operational cost and predict the possible reasons behind it. List the findings in a bullet list format. Each bullet should start with a bolded title and followed by a paragraph. Mark the positive/increasing numbers in green, and negative/decreasing numbers in red. For cost, do the opposite.” Accordingly, at a later point in time, when the administrator loads a document to display and selects the “Insightful summary” option, the client device can trigger the generation and/or display of supplemental content on the client device according to the detailed series of instructions for that respective option. The client device can display the generated supplemental content overtop of the displayed document.

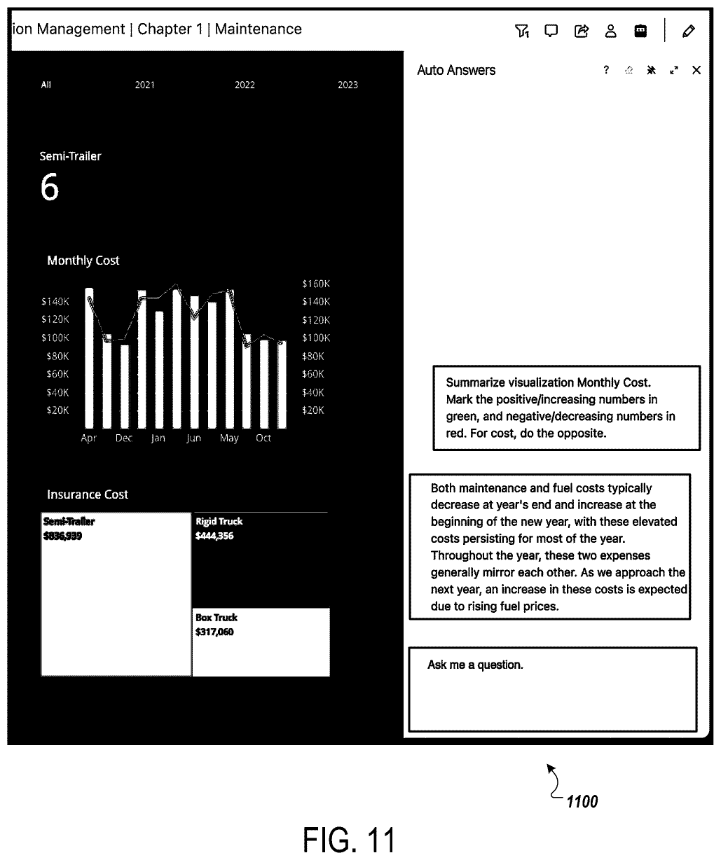

FIG. 11 is a diagram that illustrates a user interface 1100 of a chatbot that can receive instructions for generating and displaying supplemental content. The client device can display a chatbot that can receive instructions for generating supplemental content and can provide responses to the instructions. The generated supplemental content can be generated and displayed using the content shown in the document in FIG. 11. For example, the content shown in the document of FIG. 11 includes a bar chart of monthly costs, insurance costs for a semi-trailer, rigid truck, and box truck, and other information.

In the example of FIG. 11, the chatbot can receive an instruction that recites “Summarize visualization Monthly Cost. Mark the positive or increasing numbers in green, and negative or decreasing numbers in red. For cost, do the opposite.” The client device can trigger the generation of supplemental content by providing the instruction to the computer system, where the computer system performs additional processes to determine the supplemental content, e.g., the processes described with respect to stages (B) through (H) in FIG. 1. In response to producing the supplemental content, the chatbot can display the supplemental content in its textbox. The supplemental content recites, for example, “Both maintenance and fuel costs typically decrease at year's end and increase at the beginning of the new year, with these elevated costs persisting for most of the year. Throughout the year, these two expenses generally mirror each other. As we approach the next year, an increase in these costs is expected due to rising fuel prices.” Instructions provided to the chatbot and data output by the chatbot can be stored in the chatbot long-term memory 148. In some cases, the computer system 110 can retrieve supplemental content from the chatbot long-term memory 148 to provide to the client device 106 if the instruction provided to the chatbot for a particular document is relevant. In this manner, the computational cost of responding to an instruction is reduced if supplemental content can be retrieved from the chatbot long-term memory 148 instead of processed by the AI/ML service provider 130.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computer system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computer system can include clients and servers. A client and server are generally remote from each other and typically interact through a communication network. The relationship of client and server arises by virtue of computer programs running on the respective computers and having a client-server relationship to each other.

Although a few implementations have been described in detail above, other modifications are possible. For example, while a client application is described as accessing the delegate(s), in other implementations the delegate(s) may be employed by other applications implemented by one or more processors, such as an application executing on one or more servers. In addition, the logic flows depicted in the figures do not require the particular order shown, or sequential order, to achieve desirable results. In addition, other actions may be provided, or actions may be eliminated, from the described flows, and other components may be added to, or removed from, the described systems. Accordingly, other implementations are within the scope of the following claims.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

1. A method performed by one or more computers, the method comprising:
receiving, by the one or more computers, data indicating a user interaction of a user at a user interface that displays a document;
in response to receiving the data indicating the user interaction, determining, by the one or more computers, a scope of data corresponding to a particular portion of the document;
retrieving, by the one or more computers, data for the determined scope corresponding to the particular portion of the document;
performing, by the one or more computers, one or more analysis processes on the retrieved data to generate analysis results for the retrieved data;
sending, by the one or more computers, a request to one or more artificial intelligence and/or machine learning (AI/ML) models, wherein the request comprises (i) at least a portion of the retrieved data, (ii) the analysis results, and (iii) a predetermined instruction to the one or more AI/ML models that was not provided by the user; and
providing, by the one or more computers, text generated by the one or more AI/ML models for presentation in the user interface with the document in response to the user interaction.

2. The method of claim 1, wherein receiving the data indicating the user interaction comprises receiving data indicating the user interaction from a user device over a network; and
wherein providing the text comprises providing the text over a network to the user device.

3. The method of claim 1, wherein determining the scope of data corresponding to the particular portion of the document comprises at least one of:
determining one or more data series described or represented in a current state of the document;
determining the scope of data representing data currently viewable in the user interface;
determining the scope of data based on one or more filter settings applied by the user; or
determining the scope of data based on a selection in the user interface made by the user.

4. The method of claim 1, wherein retrieving data for the determined scope comprises at least one of:
accessing cached database retrieval results used to generate the particular portion of the document;
obtaining results of a database query used to generate content in the user interface;
accessing data corresponding to a user-selected portion of the user interface; or
accessing data corresponding to the document based on a session identifier corresponding to the user interface, a document identifier for the document, a page identifier for a page in the document.

5. The method of claim 1, comprising storing the predetermined instruction in association with the document before the document is displayed in the user interface in a current session; and
wherein the method includes generating the request based on the stored predetermined instruction.

6. The method of claim 1, wherein determining the scope comprises determining at least one of:
a data set corresponding to the particular portion of the document;
one or more data series represented in the particular portion of the document; or
one or more values in which to filter or restrict a data set.

7. The method of claim 1, wherein the particular portion is a particular page of the document, a particular visualization in the document, a particular view of the document, or a user-selected portion of the document.

8. The method of claim 1, wherein the provide a narrative summary of a visualization, determined based on analysis of underlying data series shown in the visualization.

9. The method of claim 1, wherein the document is a dynamic document that is linked to a data set, wherein content of the document is configured to vary based on changes in the underlying data set, and wherein the retrieved data is based on data used in a state of the document at the time the user interaction occurred.

10. The method of claim 9, wherein the dynamic document is a dashboard configured to adjust displayed content based on user settings for one or more interactive controls in the user interface; and
wherein the scope of the data is determined based on the user settings for the one or more interactive controls.

11. The method of claim 1, wherein the request to the one or more AI/ML models further comprises information from a data model for a data set used to generate content of the document.

12. The method of claim 1, wherein the document comprises multiple different objects or components in the document, and wherein the predetermined instruction comprises a reference to one or more of the objects or components in the document.

13. The method of claim 12, wherein the objects or components comprise a visualization, and wherein the predetermined instruction comprises text instructing the one or more AI/ML models to generate a summary of the visualization.

14. The method of claim 1, comprising storing multiple different custom instructions corresponding to different data types or different portions of the user interface;
wherein the one or more computer are configured to use different instructions of the stored custom instructions to generate a request to the one or more AI/ML models depending on a user interface element interacted with or a portion of the document displayed in the user interface.

15. The method of claim 1, wherein performing the one or more analysis processes on the retrieved data comprises performing at least one of trend analysis, key factor analysis, and forecasting analysis.

16. A system comprising:
one or more computers; and
one or more computer-readable media storing instructions that are operable, when executed by the one or more computers, to cause the system to perform operations comprising:
receiving, by the one or more computers, data indicating a user interaction of a user at a user interface that displays a document;
in response to receiving the data indicating the user interaction, determining, by the one or more computers, a scope of data corresponding to a particular portion of the document;
retrieving, by the one or more computers, data for the determined scope corresponding to the particular portion of the document;
performing, by the one or more computers, one or more analysis processes on the retrieved data to generate analysis results for the retrieved data;
sending, by the one or more computers, a request to one or more artificial intelligence and/or machine learning (AI/ML) models, wherein the request comprises (i) at least a portion of the retrieved data, (ii) the analysis results, and (iii) a predetermined instruction to the one or more AI/ML models that was not provided by the user; and
providing, by the one or more computers, text generated by the one or more AI/ML models for presentation in the user interface with the document in response to the user interaction.

17. The method of claim 16, wherein receiving the data indicating the user interaction comprises receiving data indicating the user interaction from a user device over a network; and
wherein providing the text comprises providing the text over a network to the user device.

18. The method of claim 16, wherein determining the scope of data corresponding to the particular portion of the document comprises at least one of:
determining one or more data series described or represented in a current state of the document;
determining the scope of data representing data currently viewable in the user interface;
determining the scope of data based on one or more filter settings applied by the user; or
determining the scope of data based on a selection in the user interface made by the user.

19. The method of claim 16, wherein retrieving data for the determined scope comprises at least one of:
accessing cached database retrieval results used to generate the particular portion of the document;
obtaining results of a database query used to generate content in the user interface;
accessing data corresponding to a user-selected portion of the user interface; or
accessing data corresponding to the document based on a session identifier corresponding to the user interface, a document identifier for the document, a page identifier for a page in the document.

20. One or more non-transitory computer-readable media storing instructions that are operable, when executed by one or more computers, to cause the system to perform operations comprising:
receiving, by the one or more computers, data indicating a user interaction of a user at a user interface that displays a document;
in response to receiving the data indicating the user interaction, determining, by the one or more computers, a scope of data corresponding to a particular portion of the document;
retrieving, by the one or more computers, data for the determined scope corresponding to the particular portion of the document;
performing, by the one or more computers, one or more analysis processes on the retrieved data to generate analysis results for the retrieved data;
sending, by the one or more computers, a request to one or more artificial intelligence and/or machine learning (AI/ML) models, wherein the request comprises (i) at least a portion of the retrieved data, (ii) the analysis results, and (iii) a predetermined instruction to the one or more AI/ML models that was not provided by the user; and
providing, by the one or more computers, text generated by the one or more AI/ML models for presentation in the user interface with the document in response to the user interaction.
